(19) United States
(12) Patent Application Publication
(10) Pub. No.: US 2024/0237036 A9
(43) Pub. Date: Jul. 11, 2024

(54) TRANSMIT CHAIN SWITCHING PREPARATION TIME FOR UPLINK SHARED CHANNEL

(71) Applicant: QUALCOMM Incorporated, San Diego, CA (US)

(72) Inventors: Yiqing CAO, Beijing (CN); Peter GAAL, San Diego, CA (US); Timo Ville VINTOLA, San Diego, CA (US); Alberto RICO ALVARINO, San Diego, CA (US); Kazuki TAKEDA, Minato-ku (JP); Wanshi CHEN, San Diego, CA (US); Bin HAN, Beijing (CN); Yan LI, Beijing (CN); Zhimin DU, Beijing (CN)

(21) Appl. No.: 18/546,579

(22) PCT Filed: Apr. 29, 2021
(86) PCT No.: PCT/CN2021/090918

§ 371 Date: Aug. 15, 2023

(51) Int. Cl. H04W 72/51; H04L 5/00; H04W 8/24

(52) U.S. Cl. CPC H04W 72/51; H04L 5/0078; H04W 8/24

(57) ABSTRACT

Methods, systems, and devices for wireless communication are described. In some wireless communications systems, a user equipment (UE) may support two or more uplink switching periods for transmit chain switching. The UE may transmit a UE capability message indicating the UE capability to support a first uplink switching period and a second uplink switching period for transmit chain switching. The first uplink switching period and the second uplink switching period may each correspond to different switching periods associated with configuration switches between different transmit chain configurations of the UE. The UE and a base station may select an uplink switching period from among the first uplink switching period and the second uplink switching period. The UE may transmit an uplink data message to the base station after a preparation time that is based on the uplink switching period.

### CROSS REFERENCE

The present application is a 371 national stage filing of International PCT Application No. PCT/CN2021/090918 by CAO et al. entitled “TRANSMIT CHAIN SWITCHING PREPARATION TIME FOR UPLINK SHARED CHANNEL,” filed Apr. 29, 2021, which is assigned to the assignee hereof, and which is expressly incorporated by reference in its entirety herein.

### FIELD OF TECHNOLOGY

The following relates to wireless communication, including transmit chain switching preparation time for uplink shared channel.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some examples, a UE may be configured to support two concurrent uplink transmissions using a first transmit chain and a second transmit chain. The transmit chains may be configured, at any given time, to transmit on different frequency bands or component carriers. The UE may switch between transmit chain configurations during an uplink switching period.

### SUMMARY

The described techniques relate to improved methods, systems, devices, and apparatuses that support transmit chain switching preparation time for uplink shared channel. Generally, the described techniques provide for a user equipment (UE) to report two UE capabilities for uplink transmit chain switching. The UE may support two or more uplink switching periods for transmit chain switching based on which transmit chain configurations are being switched between. The UE may transmit, to a base station, a UE capability message that indicates a UE capability to support both a first uplink switching period and a second uplink switching period for transmit chain switching. Each of the first uplink switching period and the second uplink switching period may correspond to different switching periods associated with configuration switches between different transmit chain configurations of the UE. The UE and the base station may select an uplink switching period from the first and second reported uplink switching periods based on one or more configured criterion. For example, the UE and the base station may select a maximum of the two indicated uplink switching periods. Additionally or alternatively, the UE and the base station may select the uplink switching period based on a type of configuration switch, or based on signaling received from the base station. Both the UE and base station may calculate a preparation time, such as a physical uplink shared channel (PUSCH) preparation time, based on the selected switching period. The UE may transmit an uplink data message to the base station after the preparation time that is based on the selected uplink switching period.

A method for wireless communication at a UE is described. The method may include transmitting a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE, selecting an uplink switching period from among the first uplink switching period and the second uplink switching period, and transmitting an uplink data message after a preparation time that is based on the uplink switching period.

An apparatus for wireless communication is described. The apparatus may include a processor, memory coupled with the processor, and instructions stored in the memory. The instructions may be executable by the processor to cause the apparatus to transmit a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE, select an uplink switching period from among the first uplink switching period and the second uplink switching period, and transmit an uplink data message after a preparation time that is based on the uplink switching period.

Another apparatus for wireless communication is described. The apparatus may include means for transmitting a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE, means for selecting an uplink switching period from among the first uplink switching period and the second uplink switching period, and means for transmitting an uplink data message after a preparation time that is based on the uplink switching period.

A non-transitory computer-readable medium storing code for wireless communication at a UE is described. The code may include instructions executable by a processor to transmit a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE, select an uplink switching period from among the first uplink switching period and the second uplink switching period, and transmit an uplink data message after a preparation time that is based on the uplink switching period.

In some examples of the method, apparatuses, and non-transitory computer-readable medium described herein, transmitting the UE capability message may include operations, features, means, or instructions for transmitting the UE capability message including a first uplink switching period parameter configured to indicate the UE capability to support the first uplink switching period and a second uplink switching period parameter configured to indicate the UE capability to support the second uplink switching period.

Some examples of the method, apparatuses, and non-transitory computer-readable medium described herein may further include operations, features, means, or instructions for selecting the first uplink switching period supported by the UE from a first set of configured uplink switching periods corresponding to the first uplink switching period parameter and selecting the second uplink switching period supported by the UE from a second set of configured uplink switching periods corresponding to the second uplink switching period parameter.

Some examples of the method, apparatuses, and non-transitory computer-readable medium described herein may further include operations, features, means, or instructions for determining a PUSCH preparation time in accordance with the uplink switching period, where the PUSCH preparation time includes the uplink switching period, and where the preparation time may be based on the PUSCH preparation time.

In some examples of the method, apparatuses, and non-transitory computer-readable medium described herein, selecting the uplink switching period may include operations, features, means, or instructions for selecting a maximum duration from among a first duration corresponding to the first uplink switching period and a second duration corresponding to the second uplink switching period, where the uplink switching period includes the maximum duration.

Some examples of the method, apparatuses, and non-transitory computer-readable medium described herein may further include operations, features, means, or instructions for transmitting a second UE capability indicating that the UE supports a maximum of either one antenna port transmission or two antenna port transmissions on a frequency band of a frequency band combination configured for the transmit chain switching.

In some examples of the method, apparatuses, and non-transitory computer-readable medium described herein, selecting the uplink switching period may include operations, features, means, or instructions for selecting the uplink switching period based on the second UE capability, where the first uplink switching period may be associated with a one antenna port transmission on the frequency band of the frequency band combination and the second uplink switching period may be associated with a two antenna port transmission on the frequency band of the frequency band combination.

Some examples of the method, apparatuses, and non-transitory computer-readable medium described herein may further include operations, features, means, or instructions for receiving a control signal indicating the first uplink switching period or the second uplink switching period, where selecting the uplink switching period may be based on the control signal.

Some examples of the method, apparatuses, and non-transitory computer-readable medium described herein may further include operations, features, means, or instructions for receiving a control signal that schedules transmission of the uplink data message according to a first transmit chain configuration, where the uplink switching period corresponds to a switching period associated with a configuration switch between the first transmit chain configuration and a second transmit chain configuration of the UE.

Some examples of the method, apparatuses, and non-transitory computer-readable medium described herein may further include operations, features, means, or instructions for determining that the UE supports a first transmit chain and a second transmit chain changeably configured for a one-port transmission, a two-port transmission, or no transmission on each of a first carrier and a second carrier, where transmitting the UE capability message may be based on the determining.

In some examples of the method, apparatuses, and non-transitory computer-readable medium described herein, the first uplink switching period supports a switching period associated with a configuration switch between a first transmit chain configuration that supports the one-port transmission on the first carrier and a second transmit chain configuration that supports the two-port transmission on the second carrier.

In some examples of the method, apparatuses, and non-transitory computer-readable medium described herein, the first uplink switching period supports a switching period associated with a configuration switch between a first transmit chain configuration that supports the two-port transmission on the first carrier and a second transmit chain configuration that supports the one-port transmission on the second carrier.

In some examples of the method, apparatuses, and non-transitory computer-readable medium described herein, the second uplink switching period supports a switching period associated with a configuration switch between a first transmit chain configuration that supports the two-port transmission on the first carrier and a second transmit chain configuration that supports the two-port transmission on the second carrier.

In some examples of the method, apparatuses, and non-transitory computer-readable medium described herein, transmitting the uplink data message may include operations, features, means, or instructions for transmitting a first uplink data message on a first carrier, switching at least one of a first transmit chain or a second transmit chain between the first carrier and a second carrier during the preparation time, and transmitting the uplink data message on the second carrier in accordance with the switching.

A method for wireless communication at a base station is described. The method may include receiving, from a UE, a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE, selecting an uplink switching period from among the first uplink switching period and the second uplink switching period, and receiving, from the UE, an uplink data message after a preparation time that is based on the uplink switching period.

An apparatus for wireless communication is described. The apparatus may include a processor, memory coupled with the processor, and instructions stored in the memory. The instructions may be executable by the processor to cause the apparatus to receive, from a UE, a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE, select an uplink switching period from among the first uplink switching period and the second uplink switching period, and receive, from the UE, an uplink data message after a preparation time that is based on the uplink switching period.

Another apparatus for wireless communication is described. The apparatus may include means for receiving, from a UE, a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE, means for selecting an uplink switching period from among the first uplink switching period and the second uplink switching period, and means for receiving, from the UE, an uplink data message after a preparation time that is based on the uplink switching period.

A non-transitory computer-readable medium storing code for wireless communication at a base station is described. The code may include instructions executable by a processor to receive, from a UE, a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE, select an uplink switching period from among the first uplink switching period and the second uplink switching period, and receive, from the UE, an uplink data message after a preparation time that is based on the uplink switching period.

In some examples of the method, apparatuses, and non-transitory computer-readable medium described herein, receiving the UE capability message may include operations, features, means, or instructions for receiving the UE capability message including a first uplink switching period parameter configured to indicate the UE capability to support the first uplink switching period and a second uplink switching period parameter configured to indicate the UE capability to support the second uplink switching period.

In some examples of the method, apparatuses, and non-transitory computer-readable medium described herein, the first uplink switching period supported by the UE may be selected from a first set of configured uplink switching periods corresponding to the first uplink switching period parameter and the second uplink switching period supported by the UE may be selected from a second set of configured uplink switching periods corresponding to the second uplink switching period parameter.

Some examples of the method, apparatuses, and non-transitory computer-readable medium described herein may further include operations, features, means, or instructions for determining a PUSCH preparation time in accordance with the uplink switching period, where the PUSCH preparation time includes the uplink switching period, and where the preparation time may be based on the PUSCH preparation time.

In some examples of the method, apparatuses, and non-transitory computer-readable medium described herein, selecting the uplink switching period may include operations, features, means, or instructions for selecting a maximum duration from among a first duration corresponding to the first uplink switching period and a second duration corresponding to the second uplink switching period, where the uplink switching period includes the maximum duration.

Some examples of the method, apparatuses, and non-transitory computer-readable medium described herein may further include operations, features, means, or instructions for receiving a second UE capability indicating that the UE supports a maximum of either one antenna port transmission or two antenna port transmissions on a frequency band of a frequency band combination configured for the transmit chain switching.

In some examples of the method, apparatuses, and non-transitory computer-readable medium described herein, selecting the uplink switching period may include operations, features, means, or instructions for selecting the uplink switching period based on the second UE capability, where the first uplink switching period may be associated with a one antenna port transmission on the frequency band of the frequency band combination and the second uplink switching period may be associated with a two antenna port transmission on the frequency band of the frequency band combination.

Some examples of the method, apparatuses, and non-transitory computer-readable medium described herein may further include operations, features, means, or instructions for transmitting a control signal indicating the first uplink switching period or the second uplink switching period, where selecting the uplink switching period may be based on the control signal.

Some examples of the method, apparatuses, and non-transitory computer-readable medium described herein may further include operations, features, means, or instructions for transmitting a control signal that schedules transmission of the uplink data message according to a first transmit chain configuration, where the uplink switching period corresponds to a switching period associated with a configuration switch between the first transmit chain configuration and a second transmit chain configuration of the UE.

Some examples of the method, apparatuses, and non-transitory computer-readable medium described herein may further include operations, features, means, or instructions for determining that the UE supports a first transmit chain and a second transmit chain changeably configured for a one-port transmission, a two-port transmission, or no transmission on each of a first carrier and a second carrier, where receiving the UE capability message may be based on the determining.

In some examples of the method, apparatuses, and non-transitory computer-readable medium described herein, the first uplink switching period supports a switching period associated with a configuration switch between a first transmit chain configuration that supports the one-port transmission on the first carrier and a second transmit chain configuration that supports the two-port transmission on the second carrier.

In some examples of the method, apparatuses, and non-transitory computer-readable medium described herein, the first uplink switching period supports a switching period associated with a configuration switch between a first transmit chain configuration that supports the two-port transmission on the first carrier and a second transmit chain configuration that supports the one-port transmission on the second carrier.

In some examples of the method, apparatuses, and non-transitory computer-readable medium described herein, the second uplink switching period supports a switching period associated with a configuration switch between a first transmit chain configuration that supports the two-port transmission on the first carrier and a second transmit chain configuration that supports the two-port transmission on the second carrier.

In some examples of the method, apparatuses, and non-transitory computer-readable medium described herein, receiving the uplink data message may include operations, features, means, or instructions for receiving a first uplink data message on a first carrier and receiving the uplink data message on a second carrier after the preparation time.

### BRIEF DESCRIPTION OF THE DRAWINGS

FIG. 1 illustrates an example of a wireless communications system that supports transmit chain switching preparation time for uplink shared channel in accordance with aspects of the present disclosure.

FIG. 2 illustrates an example of a wireless communications system that supports transmit chain switching preparation time for uplink shared channel in accordance with aspects of the present disclosure.

FIG. 3 illustrates an example of a carrier switching timeline that supports transmit chain switching preparation time for uplink shared channel in accordance with aspects of the present disclosure.

FIG. 4 illustrates an example of a process flow that supports transmit chain switching preparation time for uplink shared channel in accordance with aspects of the present disclosure.

FIGS. 5 and 6 show block diagrams of devices that support transmit chain switching preparation time for uplink shared channel in accordance with aspects of the present disclosure.

FIG. 7 shows a block diagram of a communications manager that supports transmit chain switching preparation time for uplink shared channel in accordance with aspects of the present disclosure.

FIG. 8 shows a diagram of a system including a device that supports transmit chain switching preparation time for uplink shared channel in accordance with aspects of the present disclosure.

FIGS. 9 and 10 show block diagrams of devices that support transmit chain switching preparation time for uplink shared channel in accordance with aspects of the present disclosure.

FIG. 11 shows a block diagram of a communications manager that supports transmit chain switching preparation time for uplink shared channel in accordance with aspects of the present disclosure.

FIG. 12 shows a diagram of a system including a device that supports transmit chain switching preparation time for uplink shared channel in accordance with aspects of the present disclosure.

FIGS. 13 through 16 show flowcharts illustrating methods that support transmit chain switching preparation time for uplink shared channel in accordance with aspects of the present disclosure.

### DETAILED DESCRIPTION

In some wireless communications systems, a user equipment (UE) may be configured to support two concurrent transmissions using a first transmit chain and a second transmit chain. The transmit chains may be configured, at a given time, to transmit on different frequency bands or component carriers. That is, a UE may support one or more of a 1T+1T configuration, a 0T+2T configuration, or a 2T+0T configuration, where T represents an active transmit chain or a quantity of supported antenna ports on each component carrier or frequency band. The UE may switch between different transmit chain configurations during a respective uplink switching period. In some cases, the UE may report an uplink switching period as a UE capability, and a UE capability report may be configured to convey a single UE switching capability. However, some UEs may be configured with transmit chain configurations corresponding to two or more uplink switching periods. That is, a UE may, in some examples, support different uplink switching capabilities based on which transmit chain configuration is being switched to and from.

As described herein, a UE may signal support for two uplink switching periods via a UE capability message. The indicated switching periods may be for different types of configuration switches between different transmit chain configurations of the UE. For example, the configuration switches may include a switch between a one antenna port transmit chain configuration on a first carrier and a two antenna port transmit chain configuration on a second carrier, or a switch between a two antenna port transmit chain configuration on the first carrier and a two antenna port transmit chain configuration on the second carrier, or any other switch between transmit chain configurations. As such, the UE capability message described herein may include two uplink switching period parameters.

The UE and the base station may use one or more selection schemes to determine which uplink switching period of the two or more reported uplink switching periods to apply for communications. In one example, a maximum of the two reported uplink switching periods may be selected. In other examples, the uplink switching period may be dynamically selected for each scheduled transmission based on a type of the configuration switch. Additionally or alternatively, the UE may report a second UE capability indicating support for either a one antenna port transmission or two antenna port transmission on each frequency band of a frequency band combination, and the switching period may be based on the reported UE capability, based on signaling received from the base station, or both. Both the UE and base station may calculate a physical uplink shared channel (PUSCH) preparation time based on the selected uplink switching period.

Aspects of the disclosure are initially described in the context of wireless communications systems. Additional aspects of the disclosure are described with reference to carrier switching timelines and process flows. Aspects of the disclosure are further illustrated by and described with reference to apparatus diagrams, system diagrams, and flowcharts that relate to transmit chain switching preparation time for uplink shared channel.

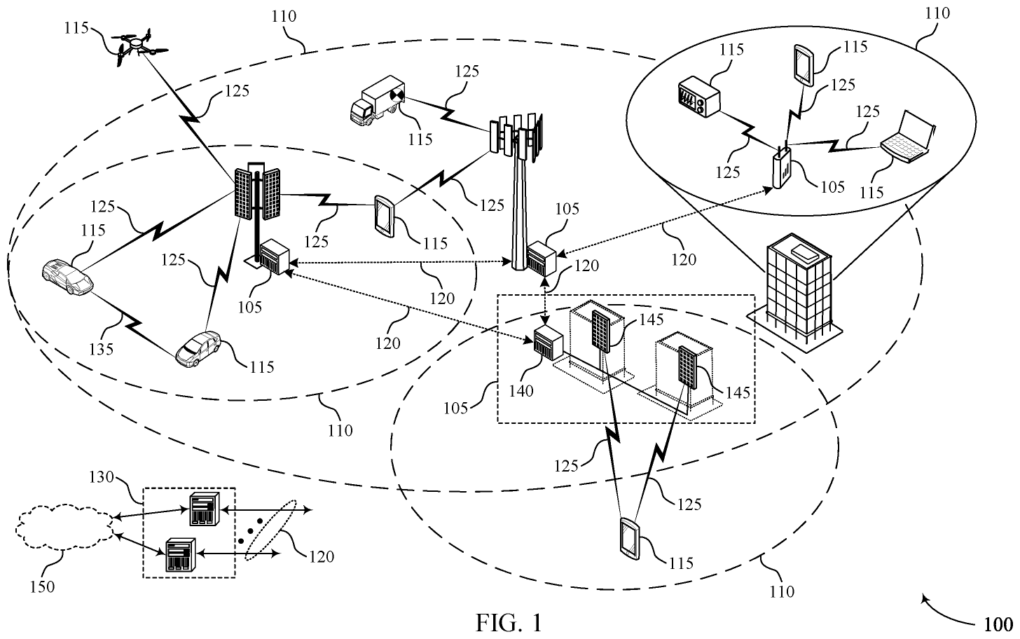

FIG. 1 illustrates an example of a wireless communications system 100 that supports transmit chain switching preparation time for uplink shared channel in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a UE 115 may report two UE capabilities for uplink transmit chain switching. The UE 115 may support two or more uplink switching periods for transmit chain switching based on which transmit chain configurations are being switched between. The UE 115 may transmit, to a base station 105, a UE capability message that indicates a UE capability to support both a first uplink switching period and a second uplink switching period for transmit chain switching. Each of the first uplink switching period and the second uplink switching period may correspond to different switching periods associated with configuration switches between different transmit chain configurations of the UE 115. The UE 115 and the base station 105 may select an uplink switching period from the first and second reported uplink switching periods based on one or more configured criterion. For example, the UE 115 and the base station 105 may select a maximum of the two indicated uplink switching periods. Additionally or alternatively, the UE 115 and the base station 105 may select the uplink switching period based on a type of configuration switch, or based on signaling received from the base station. Both the UE 115 and base station 105 may calculate a preparation time, such as a PUSCH preparation time, based on the selected switching period. The UE 115 may transmit an uplink data message to the base station 105 after the preparation time that is based on the selected uplink switching period.

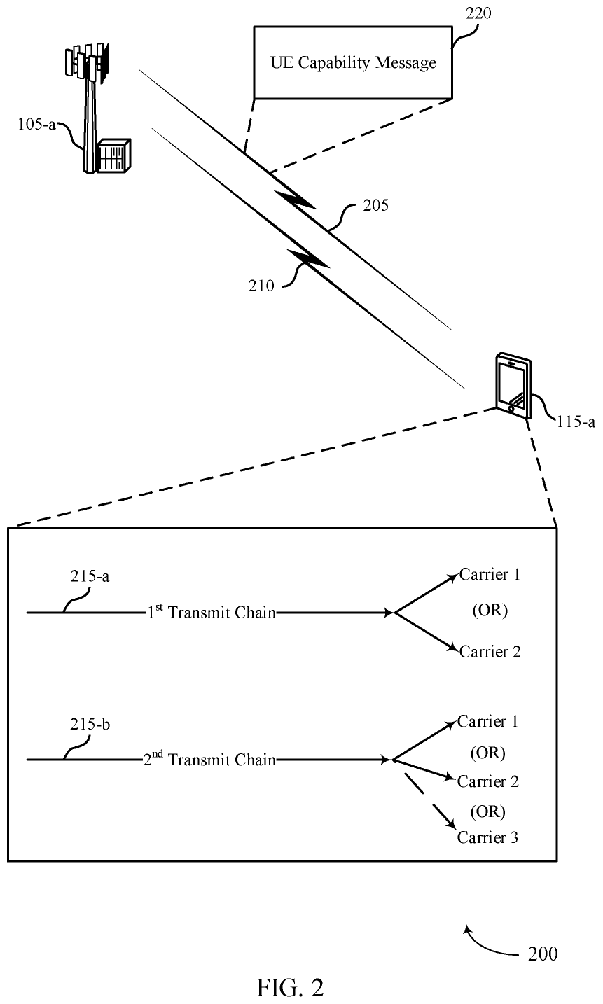

FIG. 2 illustrates an example of a wireless communications system 200 that supports transmit chain switching preparation time for uplink shared channel in accordance with aspects of the present disclosure. In some examples, the wireless communications system 200 may implement aspects of the wireless communications system 100. For example, the wireless communications system 200 may include a base station 105-a and a UE 115-a, which may represent examples of a base station 105 and a UE 115 as described with reference to FIG. 1. The UE 115-a and the base station 105-a may communicate uplink and downlink messages via a first carrier 205 (e.g., carrier 1) and a second carrier 210 (e.g., carrier 2). In some examples, the UE 115-a may transmit the UE capability message 220 to the base station 105-a via the first carrier 205, the second carrier 210, or another carrier (not pictured) to indicate one or more uplink switching periods supported by the UE 115-a.

The UE 115-a may be configured to support two transmit chains 215-a and 215-b. In some cases, the first transmit chain 215-a may be configured to support communications on the first carrier 205 (carrier 1) and the second carrier 210 (carrier 2), and the second transmit chain 215-b may be configured to support communications on the second carrier 210. In such cases, the UE 115-a may support transmit chain switching between a first transmit chain configuration (Case 1) where the first transmit chain 215-a is configured on the first carrier 205 and the second transmit chain 215-b is configured on the second carrier 210 (e.g., 1T+1T, where each T represents a quantity of transmit chains or supported antenna ports on each carrier), and a second transmit chain configuration (Case 2) where the first transmit chain 215-a and the second transmit chain 215-b are both configured on the second carrier 210 (e.g., 0T+2T).

An uplink switching period (or gap) for the UE 115-a to retune its radio frequency (RF) components (e.g., RF status) to switch transmit chains 215 may be required between uplink transmissions. The RF status of the UE 115-a may refer to the configuration of the first transmit chain 215-a and/or the second transmit chain 215-b with respect to being tuned to the first carrier 205 and/or the second carrier 210, which may additionally or alternatively be referred to as a transmit chain configuration. The RF status and/or transmit chain configuration of the UE 115-a may refer to the configuration of the first transmit chain 215-a, the second transmit chain 215-b, or both with respect to whether they are configured for a one antenna port transmission, a two antenna port transmission, or both on the first carrier 205 and/or the second carrier 210. Retuning or otherwise reconfiguring the RF status (e.g., the current RF status) of the UE 115-a may refer to retuning or reconfiguring the first transmit chain 215-a, the second transmit chain 215-b, or both between a one antenna port transmission and a two antenna port transmission on the first carrier 205 and/or the second carrier 210, or vice versa.

In the example of the wireless communications system 200, both the first transmit chain 215-a and the second transmit chain 215-b may be configured to support communications on the first carrier 205 and the second carrier 210. That is, the first transmit chain 215-a and the second transmit chain 215-b may be changeably configured to support, at any given time, a one-port transmission, a two-port transmission, or no transmission on the first carrier 205 and the second carrier 210. In such cases, a third transmit chain configuration (Case 3) may be configured for the UE 115-a. The third transmit chain configuration may correspond to both the first transmit chain 215-a and the second transmit chain 215-b configured on the first carrier 205 (e.g., 2T+0T). The UE 115-a may support transit chain switching between the first transmit chain configuration (Case 1), the second transmit chain configuration (Case 2), the third transmit chain configuration (Case 3), or any combination thereof. An example transmit chain configuration for each case is illustrated in Table 1.

TABLE 1
Transmit Chain Configurations For Case 1, Case 2, and Case 3

| | Number of Transmit Chains |
|---|---|
| | (Carrier 1 + Carrier 2) |
| Case 1 | 1 T + 1 T |
| Case 2 | 0 T + 2 T |
| Case 3 | 2 T + 0 T |

The third transmit chain configuration may be configured to support supplementary uplink (SUL) communications, inter-band uplink carrier aggregation communications, intra-band uplink carrier aggregation communications, other uplink communications, or any combination thereof. In one example, the UE 115-a may support inter-band uplink carrier aggregation. That is, the UE 115-a may support multiple carriers, such as the carriers 205 and 210, that are located in different operating frequency bands of a frequency band combination. For example, the first component carrier 205 may correspond to a first frequency band and the second component carrier 210 may correspond to a second frequency band. In such cases, the UE 115-a may support simultaneous transmissions on the first carrier 205 and the second carrier 210. The UE 115-a may support each of the first, second, and third transmit chain configurations illustrated in Table 1 while supporting inter-band uplink carrier aggregation. In some examples, an inter-band uplink carrier aggregation configuration that supports simultaneous transmission on two or more carriers may be referred to as an uplink carrier aggregation option 2.

In another example, the UE 115-a may be configured with an SUL carrier and a non-SUL carrier. The UE 115-a may not support simultaneous transmission on the SUL carrier and the non-SUL carrier. Accordingly, the first transmit chain configuration (Case 1) may not support an SUL carrier configuration. That is, because the first transmit chain configuration configures the UE 115-a to support the first transmit chain 215-a on the first carrier 205, which may be an example of the SUL carrier, and the second transmit chain 215-b on the second carrier 210, which may be an example of the non-SUL carrier, simultaneously, the first transmit chain configuration may not be compatible with the SUL configuration. As such, if the UE 115-a is configured with an SUL carrier, the UE 115-a may be configured to support uplink transmit chain switching between the second transmit chain configuration (Case 2) and the third transmit chain configuration (Case 3), but the UE 115-a may not support the first transmit chain configuration. Example transmit chain configurations for an SUL configuration are illustrated in Table 2.

TABLE 2
Transmit Chain Configurations For SUL or
Inter-Band Uplink Carrier Aggregation

| | Number of Tx Chains |
|---|---|
| | (Carrier 1 + Carrier 2) |
| Case 2 | 0 T + 2 T |
| Case 3 | 2 T + 0 T |

In some examples, the UE 115-a may be configured to support an uplink carrier aggregation option 1, which may be similar to an inter-band uplink carrier aggregation option 2, but may not support simultaneous transmission on both the first carrier 205 and the second carrier 210. As such, the uplink carrier aggregation option 1 may correspond to the second transmit chain configuration and the third transmit chain configuration as illustrated in Table 2. That is, when the UE 115-a supports the uplink carrier aggregation option 1, the UE 115-a may support uplink transmit chain switching between Case 2 and Case 3, but the UE 115-a may not support Case 1.

In another example, the UE 115-a may be configured with a frequency band combination including a first frequency band (e.g., Band A) and a second frequency band (e.g., Band B). The second frequency band may be configured to support intra-band uplink carrier aggregation (e.g., a two-component carrier band). That is, the second frequency band may include two or more contiguous aggregated carriers. In the example of the wireless communications system 200, the second carrier 210 and a third carrier (Carrier 3) may be contiguous carriers within the second frequency band. The first frequency band may include the first carrier 205. In such cases, the UE 115-a may support uplink transmit chain switching between three carriers. The UE 115-a may support uplink transmit chain switching between the three transmit chain configurations (Case 1, Case 2, and Case 3) as applied to respective frequency bands instead of carriers. Example transmit chain configurations for such intra-band configurations are illustrated in Table 3.

TABLE 3
Transmit Chain Configurations For Intra-Band Communications

| | Number of Transmit Chains |
|---|---|
| | (Band A + Band B) |
| Case 1 | 1 T + 1 T |
| Case 2 | 0 T + 2 T |
| Case 3 | 2 T + 0 T |

In some examples, the frequency bands may be configured as an SUL band combination. That is, the first frequency band may be an SUL frequency band and the second frequency band may be a non-SUL frequency band. The SUL frequency band may not support intra-band uplink carrier aggregation. Accordingly, the SUL frequency band may include a single SUL carrier (e.g., Carrier 1) and the non-SUL frequency band may include two or more contiguous aggregated carriers (e.g., Carrier 2 and Carrier 3). In such cases, the UE 115-a may support uplink transmit chain switching between each of the three transmit chain configurations (e.g., Case 1, Case 2, and Case 3), as illustrated in Table 3.

The third transmit chain configuration (Case 3) may introduce an additional uplink switching period (gap) for the UE 115-a. For example, if the UE 115-a is configured to support uplink transmit chain switching between the first transmit chain configuration and the second transmit chain configuration, but not the third transmit chain configuration, the UE 115-a may indicate a UE capability corresponding to a first uplink switching period supported by the UE 115-a. The first uplink switching period may provide time for the UE 115-a to switch between a one-port transmission on the first carrier 205 and a two-port transmission on the second carrier 210, or vice-versa. If the UE 115-a is configured to support uplink transmit chain switching between each of the first transmit chain configuration, the second transmit chain configuration, and the third transmit chain configuration, the UE 115-a may perform transmit chain switching according to the first uplink switching period, and the UE 115-a may additionally or alternatively perform transmit chain switching between a two-port transmission on the first carrier 205 and a two-port transmission on the second carrier 210 (e.g., for switching between Case 2 and Case 3) according to a second uplink switching period. The second uplink switching period for switching between Case 2 and Case 3 may be different than the first uplink switching period for switching between Case 1 and Case 2 or Case 1 and Case 3.

The UE 115-a may transmit the UE capability message 220 to indicate a supported uplink switching period. In some cases, the UE capability message 220 may include a first uplink switching period parameter (e.g., uplinkTxSwitchingPeriod-r16) that is configured to indicate the first uplink switching period for switching between a one-port transmission on the first carrier 205 and a two-port transmission on the second carrier 210, or vice-versa. The uplink switching period parameter may include a set of potential uplink switching period durations (e.g., [35 us, 140 us, 210 us], or some other set of uplink switching period durations), and the UE 115-a may select the first uplink switching period that is supported by the UE 115-a from the set of uplink switching periods. The base station 105-a may prepare to receive uplink transmissions from the UE 115-a via the first carrier 205 and/or the second carrier 210 accordingly. However, if the UE 115-a supports a second uplink switching capability for switching between a two-port transmission on the first carrier 205 and a two-port transmission on the second carrier 210 (e.g., between Case 2 and Case 3), the UE capability message 220 may, in some cases, not include a parameter configured to convey the second supported uplink switching period.

As described herein, the UE capability message 220 may include a UE capability report configured to convey two or more uplink switching periods that are supported by the UE 115-a. In other words, the UE 115-a may report, via the UE capability message 220, one or more uplink switching values as UE capabilities. The UE capability report may include a first uplink switching period parameter (e.g., uplinkTxSwitchingPeriod-r17-1Tx-2Tx) and a second uplink switching period parameter (e.g., uplinkTxSwitchingPeriod-r17-2Tx-2Tx) for conveying the two uplink switching periods that are supported by the UE 115-a. The first uplink switching period parameter may indicate a first uplink switching period supported by the UE 115-a for switching between one transmit chain 215 and two transmit chains 215 on a single carrier (e.g., 1Tx-2Tx). In other words, the first uplink switching period may support a configuration switch between the first transmit chain configuration that supports a one-port transmission on one or both of the first carrier 205 or the second carrier 210 and the second or third transmit chain configuration that supports a two-port transmission on the other of the first carrier 205 or the second carrier 210. The second uplink switching period parameter may indicate a second uplink switching period supported by the UE 115-a for switching between two transmit chains on one carrier and two transmit chains on another carrier (e.g., 2Tx-2Tx). In other words, the second uplink switching period may support a configuration switch between the third and second transmit chain configurations that support a two-port transmission on the first carrier 205 and the second carrier 210, or vice versa.

The UE capability report may be configured as an information element and may be transmitted via RRC signaling, a MAC-CE, or some other uplink control signaling (e.g., via a physical uplink control channel (PUCCH) on the first carrier 205, the second carrier 210, or some other uplink carrier). An example UE capability report that includes two parameters for conveying the two uplink switching period capability values is illustrated below.

```
ULTxSwitchingBandPair-r17 ::= SEQUENCE {
  bandIndexUL1-r17 INTEGER(1.maxSimultaneousBands),
  bandIndexUL2-r17 INTEGER(1.maxSimultaneousBands),
  uplinkTxSwitchingPeriod-r17-1Tx-2Tx ENUMERATED {n35us,
  n140us, n210us},
  uplinkTxSwitchingPeriod-r17-2Tx-2Tx ENUMERATED {n35us,
  n140us, n210us},
  uplinkTxSwitching-DL-Interruption-r17 BIT STRING
(SIZE(1.maxSimultaneousBands)) OPTIONAL
```

### Example UE Capability Report

The uplink switching period parameters may each include a list of configured uplink switching period values for the UE 115-a to select from. The UE 115-a may select the first uplink switching period capability value from a first list corresponding to the first parameter and the second uplink switching period capability value from a second list corresponding to the second parameter. In the example UE capability report illustrated above, the first uplink switching period parameter and the second uplink switching period parameter may correspond to a same list of configured uplink switching periods (e.g., 35 us, 140 us, and 210 us). Additionally or alternatively, the first uplink switching period parameter and the second uplink switching period parameter may correspond to different lists that include different configured uplink switching period values.

It is to be understood that while the example UE capability report is shown to include the illustrated parameters and values, a UE capability report may include any parameters or convey any values, including parameters and values not shown in the example UE capability report. In some examples, the UE 115-a may indicate two or more supported uplink switching periods via another information element or control signal different than the example UE capability report illustrated, or the UE 115-a may indicate the supported uplink switching periods via additional parameters not illustrated.

Accordingly, the UE 115-a may indicate a first uplink switching capability corresponding to a first uplink switching period supported by the UE 115-a and a second uplink switching capability corresponding to a second uplink switching period supported by the UE 115-a. Additionally or alternatively, the UE 115-a may indicate a single uplink switching capability, or the first uplink switching period and the second uplink switching period may be the same. In some examples, the UE 115-a may indicate, via the UE capability message 220 or some other control signaling, a second UE capability. The second UE capability may indicate that the UE 115-a supports a maximum of either a one antenna port transmission or a two antenna port transmission on a given frequency band of a frequency band combination configured for uplink transmit chain switching. In some examples, the UE 115-a may transmit the second UE capability if the UE 115-a supports intra-band uplink carrier aggregation on the frequency band combination.

The base station 105-a may receive an indication of the supported uplink switching capabilities via the UE capability message 220. The base station 105-a and the UE 115-a may select an uplink switching period (e.g., T switch) from the reported uplink switching periods to apply to subsequent uplink communications. The base station 105-a and the UE 115-a may be configured with one or more selection schemes for selecting the uplink switching period. In one example, the base station 105-a and the UE 115-a may be configured to select a maximum uplink switching period from the reported uplink switching periods. That is, a switching period that includes the longest duration of each of the reported switching period capabilities may be selected and applied for communications. If the UE 115-a reports two uplink switching periods via two uplink switching period parameters (e.g., uplinkTxSwitchingPeriod-r17-1Tx-2Tx and uplinkTxSwitchingPeriod-r17-2Tx-2Tx), the UE 115-a and the base station 105-a may select an uplink switching period according to Equation 1.

T_{switch}=max(uplinkTxSwitchingPeriod-r17-1Tx-2Tx,uplinkTxSwitchingPeriod-r17-2Tx-2Tx) Equation (1)

In another example, the base station 105-a and the UE 115-a may be configured to select the uplink switching period based on the second UE capability to support a maximum of either the one-port transmission or the two-port transmission on each frequency band in a given frequency band combination. The UE 115-a may support two uplink switching modes. A first mode (Mode 1) may correspond to the first uplink switching period for switching between a one-port transmission on a first frequency band and a two-port transmission on a second frequency band (e.g., 1Tx-2Tx) A second mode (Mode 2) may correspond to the second uplink switching period for switching between a two-port transmission on a first frequency band a two-port transmission on a second frequency band (e.g., 2Tx-2Tx). Within one mode, the UE 115-a may use the switching period associated with the respective mode. For a given frequency band combination (e.g., frequency band X and frequency band Y), if the UE 115-a indicates a maximum supported antenna port capability of two antenna ports on each frequency band of the frequency band combination (e.g., on each of the frequency band X and the frequency band Y), the base station 105-a and the UE 115-a may select the second uplink switching period (e.g., 2Tx-2Tx) for each transmit chain switch performed by the UE 115-a (e.g., switches between each of Case 1, Case 2, and Case 3). If the UE 115-a indicates a maximum supported antenna port capability of one antenna port on any frequency band of the frequency band combination (e.g., on at least one of the frequency band X or the frequency band Y), the UE 115-a and the base station 105-b may select the first uplink switching period (e.g., 1Tx-2Tx) for each transmit chain switch performed by the UE 115-a (e.g., switches between Case 1 and Case 2 or between Case 1 and Case 3).

In some examples, the base station 105-a may receive the indication of the second UE capability, and the base station may transmit a control signal that configures the UE 115-a to operate in either Mode 1 or Mode 2. That is, the base station 105-a may indicate, to the UE 115-a, which uplink switching period is to be selected. The base station 105-a may transmit the indication of the uplink switching period based on an implicit indication of the capabilities of the UE 115-a received via the second UE capability. The control signal may be transmitted via RRC signaling, or some other control signaling.

In another example, the base station 105-a and the UE 115-a may select the uplink switching period dynamically for each scheduling decision. The base station 105-a may transmit a control signal, such as an RRC signal, downlink control information (DCI), or some other control signal, that schedules transmission of an uplink data message by the UE 115-a according to a first transmit chain configuration. The UE 115-a may support a second transmit chain configuration prior to the scheduled uplink data message transmission (e.g., a current RF status of the UE 115-a may support the second transmit chain configuration). The UE 115-a and the base station 105-a may select the uplink switching period based on a switching period associated with a configuration switch between the first transmit chain configuration and the second transmit chain configuration of the UE 115-a. For example, if one of the first transmit chain configuration or the second transmit chain configuration corresponds to Case 1 and the other transmit chain configuration corresponds to one of Case 2 or Case 3, the UE 115-a and the base station 105-a will select the first uplink switching period (e.g., 1Tx-2Tx). If the first and second transmit chain configurations correspond to Case 2 and Case 3, the UE 115-a and the base station 105-a will select the second uplink switching period (e.g., 2Tx-2Tx).

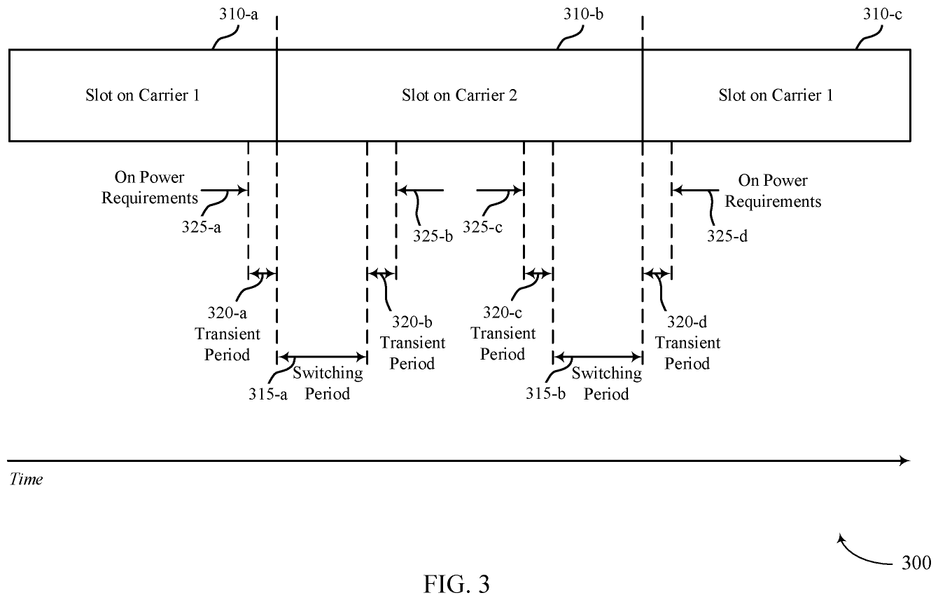

If a single uplink switching capability is reported, the base station 105-a and the UE 115-a may select the reported uplink switching capability. The base station 105-a and the UE 115-a may communicate via the first carrier 205 and/or the second carrier 210 according to the selected switching period. Details of the timing for performing the configuration switch between carriers for scheduled uplink transmissions are described in further detail elsewhere herein, including with reference to FIG. 3.

In some examples, the UE 115-a may be configured with a processing time to prepare for an uplink transmission. The processing time may be referred to as a PUSCH preparation time. The PUSCH preparation time may include one or more configured processing durations, including the uplink transmit chain switching period. For example, the UE 115-a may be configured with an equation, such as Equation 2, for calculating the PUSCH preparation time, and the equation may include the selected uplink switching period (e.g., T switch).

T_{proc,2}=max((N₂+d_{2,1}+d₂)(2048+144)·κ2^{-μ}·T_{C}+Tₑₓₜ+T_{switch},d_{2,2}) Equation (2)

The T_{switch} parameter in Equation 2 may represent the uplink switching period selected from the two or more uplink switching periods reported by the UE 115-a via the UE capability message 220 as described herein. If uplink transmit chain switching is not configured for the UE 115-a, the T_{switch} parameter may be zero. If the UE 115-a reports a single uplink switching period, the T_{switch} parameter may represent the reported uplink switching period.

In the example of Equation 2, the μ parameter may correspond to a subcarrier spacing (SCS) value associated with a downlink communication link in which a physical downlink control channel (PDCCH) carrying DCI that schedules the uplink transmission (e.g., a PUSCH) was transmitted. The N₂ parameter may be determined based on the value of μ and a processing capability of the UE 115-a (e.g., UE processing capability 1 or 2). The d_{2,1} parameter may be zero if a first symbol of the PUSCH allocation includes a demodulation reference signal (DMRS) allocation. If the first symbol of the PUSCH allocation includes allocations different than DMRS, d_{2,1} may be set to one. The d_{2,2} parameter may be set to a switching time for BWP switching if BWP switching is triggered (e.g., if a scheduling DCI triggers BWP switching). If BWP switching is not triggered, d_{2,2} may be zero. The d₂ parameter may be reported by the UE 115-a if a PUSCH of a larger priority index is to overlap with a PUCCH of a smaller priority index. Otherwise, d₂ may be set to zero. The Tₑₓₜ parameter may be calculated for an operation with shared spectrum channel access. Otherwise, Tₑₓₜ may be set to zero. The κ and T_{C} parameters may be constants.

Accordingly, the UE 115-a described herein may indicate a UE capability to support two or more uplink switching periods for transmit chain switching. The UE 115-a may and the base station 105-a may select an adequate uplink switching period from each of the reported UE capabilities based on one or more of the configured selection schemes described herein. The UE 115-a and the base station 105-a may calculate a PUSCH preparation time based on Equation 2, or some other configured equation, such that the PUSCH preparation time includes the selected uplink transmit chain switching.

FIG. 3 illustrates an example of a carrier switching timeline 300 that supports transmit chain switching preparation time for uplink shared channel in accordance with aspects of the present disclosure. In some examples, the carrier switching timeline 300 may implement or be implemented by aspects of the wireless communications systems 100 and 200. For example, the carrier switching timeline 300 illustrates a timeline for a UE 115 to switch between a first carrier and a second carrier for communications with a base station 105. The UE 115 and the base station 105 may represent examples of corresponding devices as described with reference to FIGS. 1 and 2 herein. The UE 115 may perform uplink carrier switching between the first carrier and the second carrier to transmit one or more uplink messages to the base station 105.

The UE 115 may be configured with one or more transmit chains, as described with reference to FIG. 2. The UE 115 may support uplink transmit chain switching between the first carrier and the second carrier, or between a first frequency band that includes the first carrier and a second frequency band that includes the second carrier, a third carrier (not pictured in FIG. 3), or both. As described with reference to FIG. 2 and Tables 1-3, the UE 115 may support up to three uplink transmit chain configurations. The carrier switching timeline 300 illustrates a timeline, including uplink switching periods 315 and other delays and time periods, for a UE 115 to perform a switch between transmission on a first uplink carrier and transmission on a second uplink carrier.

The carrier switching timeline 300 illustrates communications across three slots 310. In some examples, the slots 310 may represent a subslot or another TTI. The UE 115 may perform a first uplink transmission on a first carrier (Carrier 1) in the slot 310-a. The UE 115 may switch from the first carrier to the second carrier (Carrier 2) to perform a second uplink transmission in the slot 310-b. The UE 115 may subsequently switch back to the first carrier to perform a third uplink transmission in the slot 310-c. In some examples, the UE 115 may operate according to a transmit chain configuration that supports concurrent transmissions on the first carrier and the second carrier. For example, if a first transmit chain of the UE 115 is active on the first carrier and a second transmit chain of the UE 115 is active on the second carrier, the UE 115 may support simultaneous transmission on each carrier (e.g., or on two frequency bands of a frequency band combination). Although the carrier switching timeline 300 illustrates communications across three slots 310 and two carriers, the UE 115 may perform an uplink transmission and uplink transmit chain switching on any quantity of carriers or frequency bands across any quantity of TTIs.

The transient periods 320 (e.g., the transient periods 320-a, 320-b, 320-c, and 320-d) may be allocated between each slot 310 or subslot transmission. In some examples, the transient periods 320 may be a configured duration (e.g., 10 us, or some other duration). The transient periods 320 may provide time for the UE 115 to switch between the first carrier and the second carrier, for the UE 115 to switch between a first frequency band and a second frequency band, for the UE 115 to switch between transmissions, or any combination thereof.

The UE 115 may be configured with one or more on power requirements 325 (e.g., the on power requirements 325-a, 325-b, 325-c, and 325-d). If the UE 115 transmits the first uplink message using a first transmit chain on the first carrier in the slot 310-a, the on power requirement 325-a for the UE 115 may require the UE 115 to turn on the first transmit chain and maintain the first transmit chain above a threshold on power level for the duration of the slot 310-a (e.g., maintain a mean power level for each symbol duration in the slot 310-a). The on power requirement 325-a may end when the UE 115 finishes transmitting the first uplink transmission and the transient period 320-a begins. The on power requirements 325-b and 325-c may represent examples of starting and ending on power requirement 325 for the second uplink transmission on the second carrier in the slot 310-b. That is, if the UE 115 transmits the second uplink message using a second transmit chain on the second carrier, the on power requirement 325-b may indicate the UE 115 is to turn on the second transmit chain and maintain the second transmit chain at or above a threshold on power level until the end of the on power requirement 325-c. The on power requirement 325-c may end when the UE 115 finishes the second uplink transmission and the transient period 320-c begins.

The UE 115 may perform uplink transmit chain switching during the switching periods 315-a and 315-b, which may be referred to as uplink switching periods 315. As described with reference to FIG. 2, the UE 115 may support one or more durations of uplink switching periods 315. In some examples, a first uplink switching period 315 may support a switch between one transmit chain on one of the first carrier or the second carrier and two transmit chains on the other carrier, or vice versa (e.g., 1Tx-2Tx). If the UE 115 is configured to support the third transmit chain configuration (Case 3), as described with reference to Tables 1-3, the UE 115 may support a switch between two transmit chains on the first carrier and two transmit chains on the second carrier, or vice versa (e.g., 2Tx-2Tx). In some examples, the transmit chains may represent active transmit chains or a quantity of antenna ports configured to transmit on the respective carrier or frequency band.

The UE 115 may transmit a UE capability report to a base station 105 that indicates one or more uplink switching periods 315 that are supported by the UE 115. The UE 115 and the base station 105 may select an uplink switching period from the one or more reported uplink switching periods to use for communications. Accordingly, in the example of the carrier switching timeline 300, the uplink switching periods 315-a, 315-b, or both, may be selected from one or more reporting uplink switching periods 315 based on one or more of the selection schemes described with reference to FIG. 2. In some examples, the selected uplink switching period 315 may remain constant for a time period (e.g., a configured quantity of transmit chain switches) regardless of whether the UE 115 switches one transmit chain from the first carrier to the second carrier, or two transmit chains from the first carrier to the second carrier, or vice versa during the uplink switching period 315-a. For example, each of the uplink switching periods 315-a and 315-b may be a same duration regardless of which transmit chain configuration switch the UE 115 performs during the respective uplink switching period 315. Additionally or alternatively, the UE 115 and the base station 105 may select the uplink switching period 315 dynamically for each scheduled uplink transmission.

In some examples, the UE 115 may be configured to calculate a PUSCH preparation time before transmitting each of the first, second, and third uplink messages, as described with reference to FIG. 2. Each PUSCH preparation time may include the respective uplink switching periods 315-a or 315-b. For example, a first PUSCH preparation time may be configured for the UE 115 to prepare for the second uplink transmission in the slot 310-b. The first PUSCH preparation time may be calculated according to Equation 2 or some other equation, and may include the selected uplink switching period 315-a. A second PUSCH preparation time may be configured for the UE 115 to prepare for the third uplink transmission in the slot 310-c. The second PUSCH preparation time may be calculated according to Equation 2 and may include the selected uplink switching period 315-b. In some examples, the first and second PUSCH preparation times may be configured for the UE 115 regardless of whether uplink transmit chain switching is supported by the UE 115. If uplink transmit chain switching is not supported by the UE 115, the PUSCH preparation times may not include the uplink switching periods 315.

A UE 115 may thereby perform uplink carrier switching and transmit chain switching according to the carrier switching timeline 300. The UE 115 may report a UE capability to support one or more uplink switching periods 315. The UE 115 may perform uplink transmit chain switching during one or more uplink switching periods 315 selected from among the reported uplink switching periods 315.

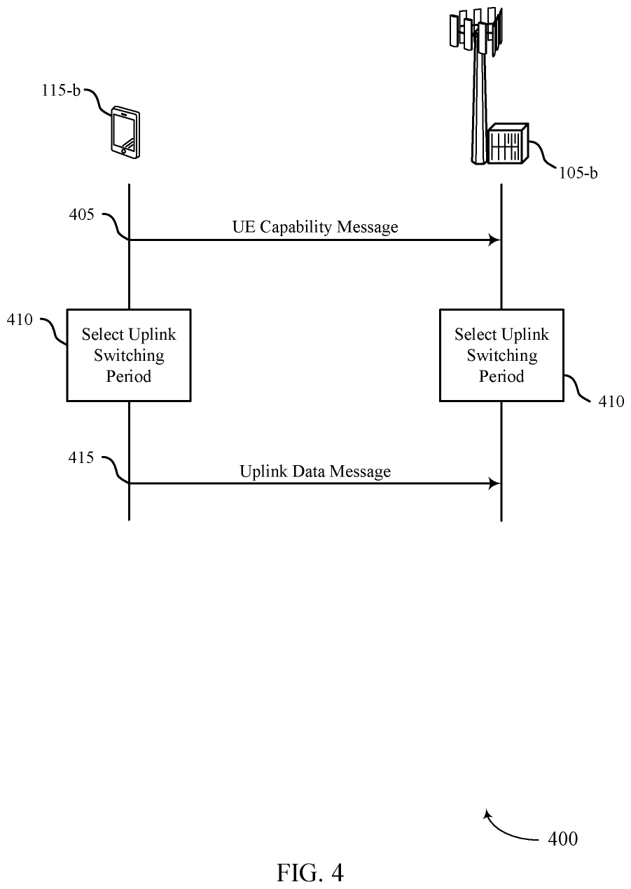

FIG. 4 illustrates an example of a process flow 400 that supports transmit chain switching preparation time for uplink shared channel in accordance with aspects of the present disclosure. The process flow 400 may implement or be implemented by some aspects of the wireless communications system 100 or 200 or the carrier switching timeline 300. For example, the process flow 400 may include a UE 115-b and a base station 105-b, which may be examples of a UE 115 and a base station 105 as described with reference to FIGS. 1-3. In some examples, the UE 115-b may transmit a UE capability message to indicate two uplink switching capabilities supported by the UE 115-b.

It is understood that the devices and nodes described by the process flow 400 may communicate with or be coupled with other devices or nodes that are not illustrated. For example, the UE 115-b and the base station 105-b may communicate with one or more other UEs 115, base stations 105, or other devices. Alternative examples of the following may be implemented, where some steps are performed in a different order than described or are not performed at all. In some cases, a step may include additional features not mentioned below, or further steps may be added.

At 405 the UE 115-b may transmit a UE capability message to the base station 105-b. The UE capability message may indicate a UE capability to support both a first uplink switching period and a second uplink switching period for transmit chain switching. The first uplink switching period and the second uplink switching period may each correspond to different switching periods associated with configuration switches between different transmit chain configurations of the UE.

At 410, the UE 115-b and the base station 105-b may select an uplink switching period from among the first uplink switching period and the second uplink switching period. In some examples, the UE 115-b and the base station 105-b may select a maximum duration from among a first duration corresponding to the first uplink switching period and a second duration corresponding to the second uplink switching period, and the selected uplink switching period may include the maximum duration. In other examples, the UE 115-b and the base station 105-b may select the uplink switching period based on a second UE capability indicating that the UE 115-b supports a maximum of either a one antenna port transmission or a two antenna port transmission on a frequency band of a frequency band combination configured for uplink transmit chain switching. In other examples, the base station 105-b may transmit a control signal to the UE 115-b indicating the uplink switching period, or the UE 115-b and the base station 105-b may select the uplink switching period based on a switching period associated with a configuration switch between a first transmit chain configuration associated with a scheduled uplink data message and a second transmit chain configuration of the UE 115-b.

At 415, the UE 115-b may transmit the uplink data message to the base station 105-b after a preparation time that is based on the uplink switching period. In some examples, the preparation time may be based on a PUSCH preparation time that includes the uplink switching period.

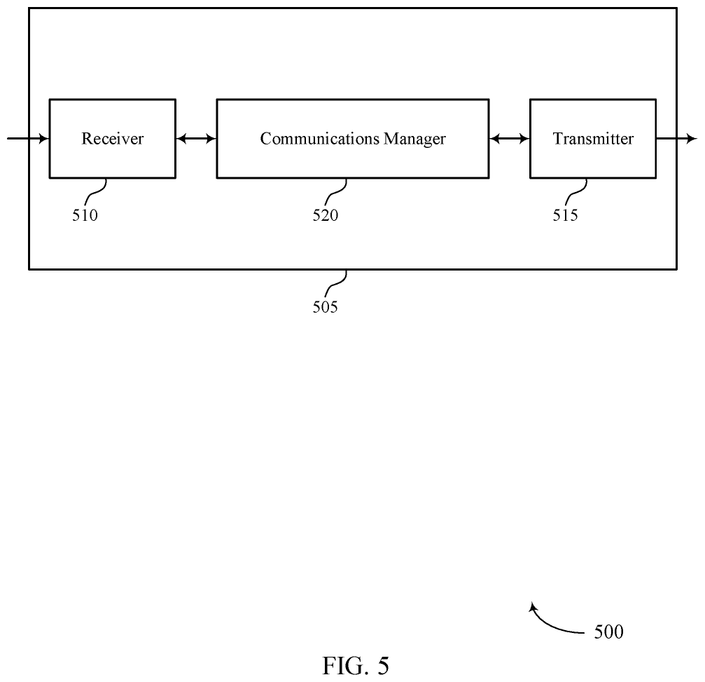

FIG. 5 shows a block diagram 500 of a device 505 that supports transmit chain switching preparation time for uplink shared channel in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to transmit chain switching preparation time for uplink shared channel). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to transmit chain switching preparation time for uplink shared channel). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of transmit chain switching preparation time for uplink shared channel as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. For example, the communications manager 520 may be configured as or otherwise support a means for transmitting a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE. The communications manager 520 may be configured as or otherwise support a means for selecting an uplink switching period from among the first uplink switching period and the second uplink switching period. The communications manager 520 may be configured as or otherwise support a means for transmitting an uplink data message after a preparation time that is based on the uplink switching period.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for reduced processing and reduced power consumption. The device 505 may support two or more uplink switching periods for uplink transmit chain switching. The processor of the device 505 may perform transmit chain switching within the two or more uplink switching periods. In some examples, the processor of the device 505 may transmit a UE capability report to indicate one or more of the uplink switching periods currently supported by the device 505. By indicating which uplink switching periods are supported, the processor may ensure that an adequate uplink switching period is configured, which may reduce latency and processing. In some examples, the processor may support a relatively short switching period, which may reduce latency and power consumption.

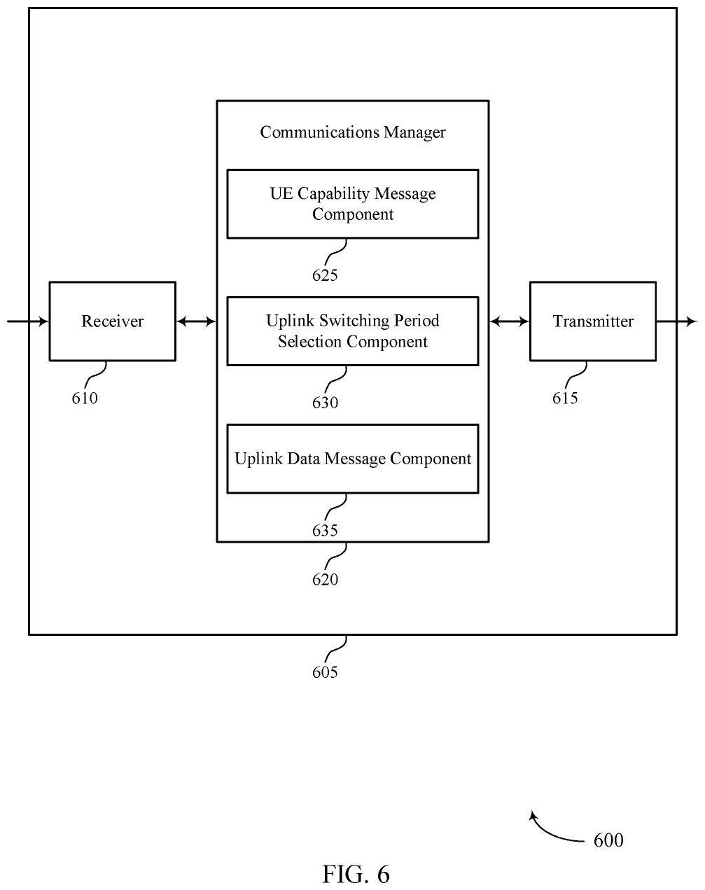

FIG. 6 shows a block diagram 600 of a device 605 that supports transmit chain switching preparation time for uplink shared channel in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to transmit chain switching preparation time for uplink shared channel). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to transmit chain switching preparation time for uplink shared channel). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of transmit chain switching preparation time for uplink shared channel as described herein. For example, the communications manager 620 may include a UE capability message component 625, an uplink switching period selection component 630, an uplink data message component 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. The UE capability message component 625 may be configured as or otherwise support a means for transmitting a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE. The uplink switching period selection component 630 may be configured as or otherwise support a means for selecting an uplink switching period from among the first uplink switching period and the second uplink switching period. The uplink data message component 635 may be configured as or otherwise support a means for transmitting an uplink data message after a preparation time that is based on the uplink switching period.

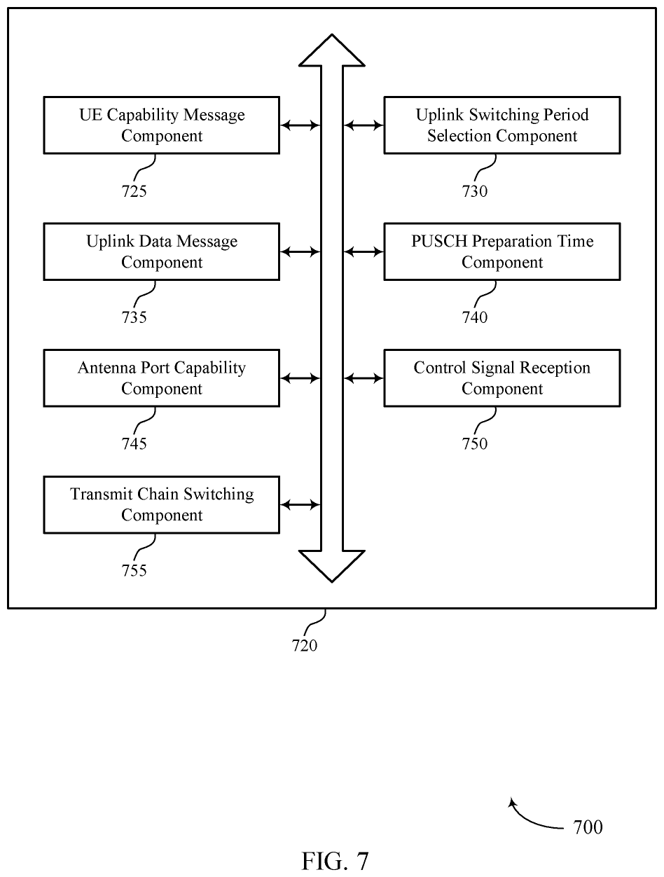

FIG. 7 shows a block diagram 700 of a communications manager 720 that supports transmit chain switching preparation time for uplink shared channel in accordance with aspects of the present disclosure. The communications manager 720 may be an example of aspects of a communications manager 520, a communications manager 620, or both, as described herein. The communications manager 720, or various components thereof, may be an example of means for performing various aspects of transmit chain switching preparation time for uplink shared channel as described herein. For example, the communications manager 720 may include a UE capability message component 725, an uplink switching period selection component 730, an uplink data message component 735, an PUSCH preparation time component 740, an antenna port capability component 745, a control signal reception component 750, a transmit chain switching component 755, or any combination thereof. Each of these components may communicate, directly or indirectly, with one another (e.g., via one or more buses).

The communications manager 720 may support wireless communication at a UE in accordance with examples as disclosed herein. The UE capability message component 725 may be configured as or otherwise support a means for transmitting a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE. The uplink switching period selection component 730 may be configured as or otherwise support a means for selecting an uplink switching period from among the first uplink switching period and the second uplink switching period. The uplink data message component 735 may be configured as or otherwise support a means for transmitting an uplink data message after a preparation time that is based on the uplink switching period.

In some examples, to support transmitting the UE capability message, the UE capability message component 725 may be configured as or otherwise support a means for transmitting the UE capability message including a first uplink switching period parameter configured to indicate the UE capability to support the first uplink switching period and a second uplink switching period parameter configured to indicate the UE capability to support the second uplink switching period.

In some examples, the uplink switching period selection component 730 may be configured as or otherwise support a means for selecting the first uplink switching period supported by the UE from a first set of configured uplink switching periods corresponding to the first uplink switching period parameter. In some examples, the uplink switching period selection component 730 may be configured as or otherwise support a means for selecting the second uplink switching period supported by the UE from a second set of configured uplink switching periods corresponding to the second uplink switching period parameter.

In some examples, the PUSCH preparation time component 740 may be configured as or otherwise support a means for determining a PUSCH preparation time in accordance with the uplink switching period, where the PUSCH preparation time includes the uplink switching period, and where the preparation time is based on the PUSCH preparation time.

In some examples, to support selecting the uplink switching period, the uplink switching period selection component 730 may be configured as or otherwise support a means for selecting a maximum duration from among a first duration corresponding to the first uplink switching period and a second duration corresponding to the second uplink switching period, where the uplink switching period includes the maximum duration.

In some examples, the antenna port capability component 745 may be configured as or otherwise support a means for transmitting a second UE capability indicating that the UE supports a maximum of either one antenna port transmission or two antenna port transmissions on a frequency band of a frequency band combination configured for the transmit chain switching.

In some examples, to support selecting the uplink switching period, the uplink switching period selection component 730 may be configured as or otherwise support a means for selecting the uplink switching period based on the second UE capability, where the first uplink switching period is associated with a one antenna port transmission on the frequency band of the frequency band combination and the second uplink switching period is associated with a two antenna port transmission on the frequency band of the frequency band combination.

In some examples, the control signal reception component 750 may be configured as or otherwise support a means for receiving a control signal indicating the first uplink switching period or the second uplink switching period, where selecting the uplink switching period is based on the control signal.

In some examples, the control signal reception component 750 may be configured as or otherwise support a means for receiving a control signal that schedules transmission of the uplink data message according to a first transmit chain configuration, where the uplink switching period corresponds to a switching period associated with a configuration switch between the first transmit chain configuration and a second transmit chain configuration of the UE.

In some examples, the UE capability message component 725 may be configured as or otherwise support a means for determining that the UE supports a first transmit chain and a second transmit chain changeably configured for a one-port transmission, a two-port transmission, or no transmission on each of a first carrier and a second carrier, where transmitting the UE capability message is based on the determining.

In some examples, the first uplink switching period supports a switching period associated with a configuration switch between a first transmit chain configuration that supports the one-port transmission on the first carrier and a second transmit chain configuration that supports the two-port transmission on the second carrier. In some examples, the first uplink switching period supports a switching period associated with a configuration switch between a first transmit chain configuration that supports the two-port transmission on the first carrier and a second transmit chain configuration that supports the one-port transmission on the second carrier.

In some examples, the second uplink switching period supports a switching period associated with a configuration switch between a first transmit chain configuration that supports the two-port transmission on the first carrier and a second transmit chain configuration that supports the two-port transmission on the second carrier.

In some examples, to support transmitting the uplink data message, the uplink data message component 735 may be configured as or otherwise support a means for transmitting a first uplink data message on a first carrier. In some examples, to support transmitting the uplink data message, the transmit chain switching component 755 may be configured as or otherwise support a means for switching at least one of a first transmit chain or a second transmit chain between the first carrier and a second carrier during the preparation time. In some examples, to support transmitting the uplink data message, the uplink data message component 735 may be configured as or otherwise support a means for transmitting the uplink data message on the second carrier in accordance with the switching.

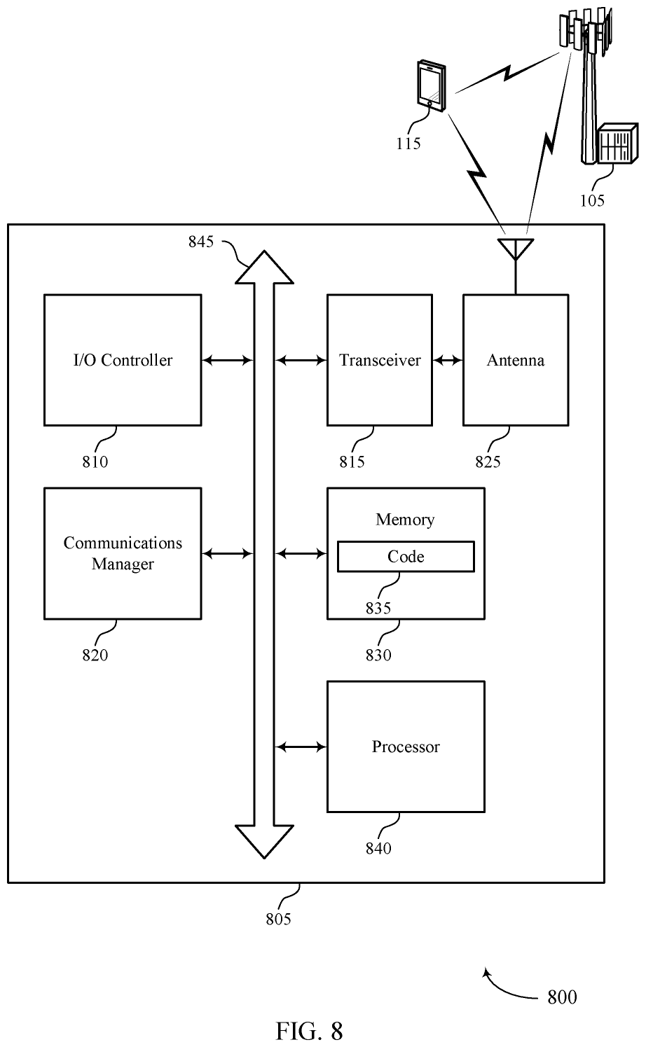

FIG. 8 shows a diagram of a system 800 including a device 805 that supports transmit chain switching preparation time for uplink shared channel in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting transmit chain switching preparation time for uplink shared channel). For example, the device 805 or a component of the device 805 may include a processor 840 and memory 830 coupled to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for transmitting a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE. The communications manager 820 may be configured as or otherwise support a means for selecting an uplink switching period from among the first uplink switching period and the second uplink switching period. The communications manager 820 may be configured as or otherwise support a means for transmitting an uplink data message after a preparation time that is based on the uplink switching period.

By including or configuring the communications manager 820 in accordance with examples as described herein, the device 805 may support techniques for improved communication reliability, reduced latency, and improved coordination between devices. The device 805 may support transmit chain switching between multiple transmit chain configurations. The device 805 may transmit a UE capability report to indicate support for one or more uplink switching periods for transmit chain switching. The device 805 and another device (e.g., a base station 105) may select an uplink switching period from the reported uplink switching periods based on one or more configured procedures, which may provide for improved coordination between devices and improved communication reliability. By selecting an uplink switching period from the reported uplink switching periods, the device 805 may support reduced latency. For example, the device 805 may support a relatively short uplink switching period.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of transmit chain switching preparation time for uplink shared channel as described herein, or the processor 840 and the memory 830 may be otherwise configured to perform or support such operations.

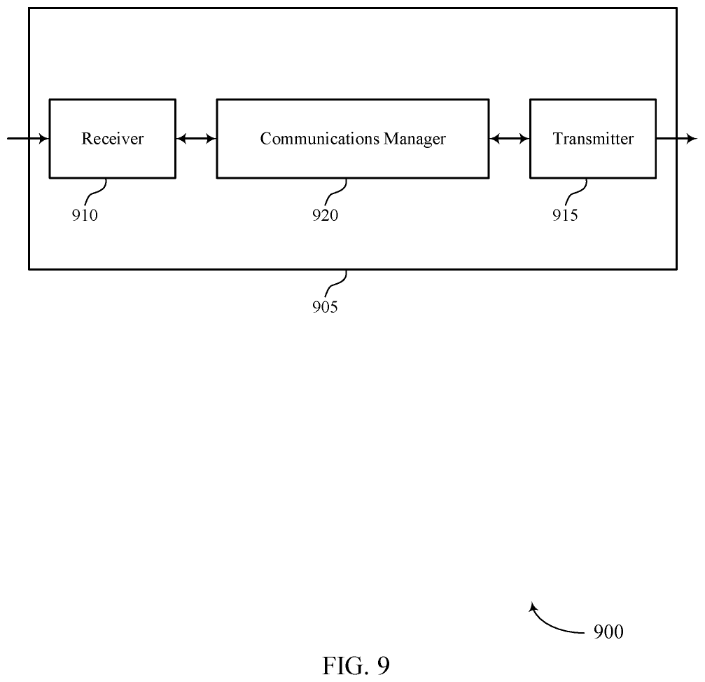

FIG. 9 shows a block diagram 900 of a device 905 that supports transmit chain switching preparation time for uplink shared channel in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to transmit chain switching preparation time for uplink shared channel). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to transmit chain switching preparation time for uplink shared channel). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of transmit chain switching preparation time for uplink shared channel as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a base station in accordance with examples as disclosed herein. For example, the communications manager 920 may be configured as or otherwise support a means for receiving, from a UE, a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE. The communications manager 920 may be configured as or otherwise support a means for selecting an uplink switching period from among the first uplink switching period and the second uplink switching period. The communications manager 920 may be configured as or otherwise support a means for receiving, from the UE, an uplink data message after a preparation time that is based on the uplink switching period.

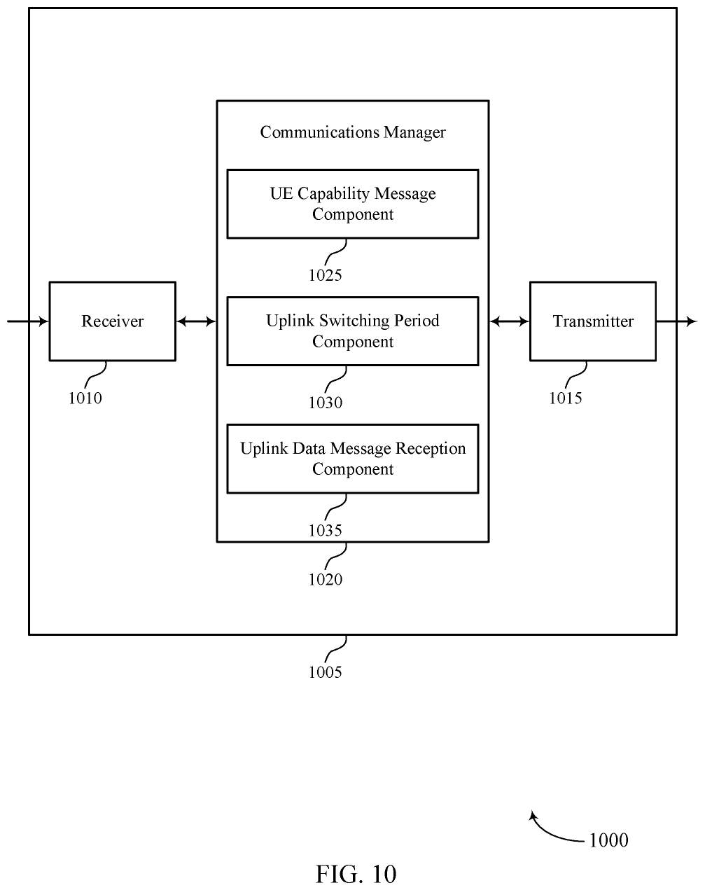

FIG. 10 shows a block diagram 1000 of a device 1005 that supports transmit chain switching preparation time for uplink shared channel in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to transmit chain switching preparation time for uplink shared channel). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to transmit chain switching preparation time for uplink shared channel). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of transmit chain switching preparation time for uplink shared channel as described herein. For example, the communications manager 1020 may include a UE capability message component 1025, an uplink switching period component 1030, an uplink data message reception component 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a base station in accordance with examples as disclosed herein. The UE capability message component 1025 may be configured as or otherwise support a means for receiving, from a UE, a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE. The uplink switching period component 1030 may be configured as or otherwise support a means for selecting an uplink switching period from among the first uplink switching period and the second uplink switching period. The uplink data message reception component 1035 may be configured as or otherwise support a means for receiving, from the UE, an uplink data message after a preparation time that is based on the uplink switching period.

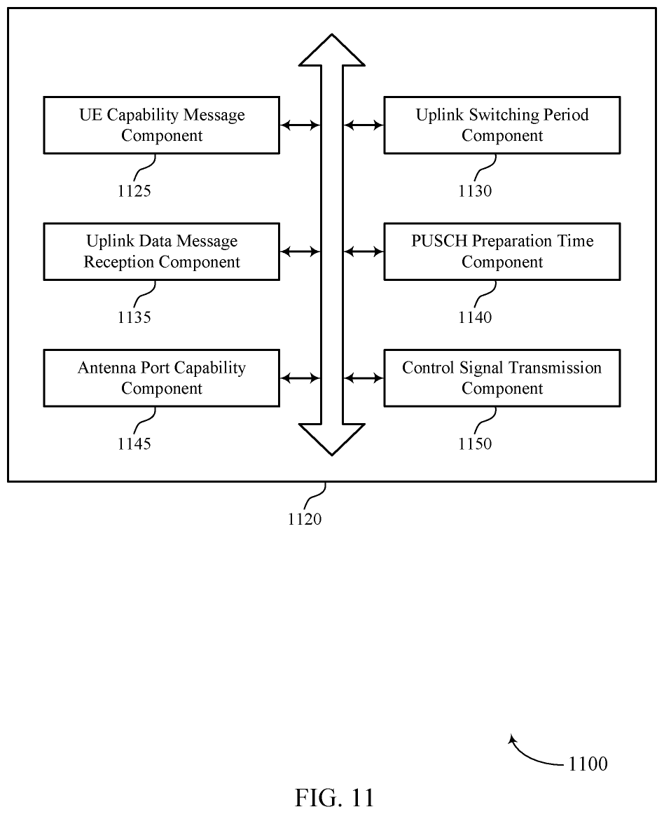

FIG. 11 shows a block diagram 1100 of a communications manager 1120 that supports transmit chain switching preparation time for uplink shared channel in accordance with aspects of the present disclosure. The communications manager 1120 may be an example of aspects of a communications manager 920, a communications manager 1020, or both, as described herein. The communications manager 1120, or various components thereof, may be an example of means for performing various aspects of transmit chain switching preparation time for uplink shared channel as described herein. For example, the communications manager 1120 may include a UE capability message component 1125, an uplink switching period component 1130, an uplink data message reception component 1135, an PUSCH preparation time component 1140, an antenna port capability component 1145, a control signal transmission component 1150, or any combination thereof. Each of these components may communicate, directly or indirectly, with one another (e.g., via one or more buses).

The communications manager 1120 may support wireless communication at a base station in accordance with examples as disclosed herein. The UE capability message component 1125 may be configured as or otherwise support a means for receiving, from a UE, a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE. The uplink switching period component 1130 may be configured as or otherwise support a means for selecting an uplink switching period from among the first uplink switching period and the second uplink switching period. The uplink data message reception component 1135 may be configured as or otherwise support a means for receiving, from the UE, an uplink data message after a preparation time that is based on the uplink switching period.

In some examples, to support receiving the UE capability message, the UE capability message component 1125 may be configured as or otherwise support a means for receiving the UE capability message including a first uplink switching period parameter configured to indicate the UE capability to support the first uplink switching period and a second uplink switching period parameter configured to indicate the UE capability to support the second uplink switching period.

In some examples, the first uplink switching period supported by the UE is selected from a first set of configured uplink switching periods corresponding to the first uplink switching period parameter. In some examples, the second uplink switching period supported by the UE is selected from a second set of configured uplink switching periods corresponding to the second uplink switching period parameter.

In some examples, the PUSCH preparation time component 1140 may be configured as or otherwise support a means for determining a PUSCH preparation time in accordance with the uplink switching period, where the PUSCH preparation time includes the uplink switching period, and where the preparation time is based on the PUSCH preparation time.

In some examples, to support selecting the uplink switching period, the uplink switching period component 1130 may be configured as or otherwise support a means for selecting a maximum duration from among a first duration corresponding to the first uplink switching period and a second duration corresponding to the second uplink switching period, where the uplink switching period includes the maximum duration.

In some examples, the antenna port capability component 1145 may be configured as or otherwise support a means for receiving a second UE capability indicating that the UE supports a maximum of either one antenna port transmission or two antenna port transmissions on a frequency band of a frequency band combination configured for the transmit chain switching.

In some examples, to support selecting the uplink switching period, the uplink switching period component 1130 may be configured as or otherwise support a means for selecting the uplink switching period based on the second UE capability, where the first uplink switching period is associated with a one antenna port transmission on the frequency band of the frequency band combination and the second uplink switching period is associated with a two antenna port transmission on the frequency band of the frequency band combination.

In some examples, the control signal transmission component 1150 may be configured as or otherwise support a means for transmitting a control signal indicating the first uplink switching period or the second uplink switching period, where selecting the uplink switching period is based on the control signal.

In some examples, the control signal transmission component 1150 may be configured as or otherwise support a means for transmitting a control signal that schedules transmission of the uplink data message according to a first transmit chain configuration, where the uplink switching period corresponds to a switching period associated with a configuration switch between the first transmit chain configuration and a second transmit chain configuration of the UE.

In some examples, the UE capability message component 1125 may be configured as or otherwise support a means for determining that the UE supports a first transmit chain and a second transmit chain changeably configured for a one-port transmission, a two-port transmission, or no transmission on each of a first carrier and a second carrier, where receiving the UE capability message is based on the determining.

In some examples, the first uplink switching period supports a switching period associated with a configuration switch between a first transmit chain configuration that supports the one-port transmission on the first carrier and a second transmit chain configuration that supports the two-port transmission on the second carrier. In some examples, the first uplink switching period supports a switching period associated with a configuration switch between a first transmit chain configuration that supports the two-port transmission on the first carrier and a second transmit chain configuration that supports the one-port transmission on the second carrier.

In some examples, the second uplink switching period supports a switching period associated with a configuration switch between a first transmit chain configuration that supports the two-port transmission on the first carrier and a second transmit chain configuration that supports the two-port transmission on the second carrier.

In some examples, to support receiving the uplink data message, the uplink data message reception component 1135 may be configured as or otherwise support a means for receiving a first uplink data message on a first carrier. In some examples, to support receiving the uplink data message, the uplink data message reception component 1135 may be configured as or otherwise support a means for receiving the uplink data message on a second carrier after the preparation time.

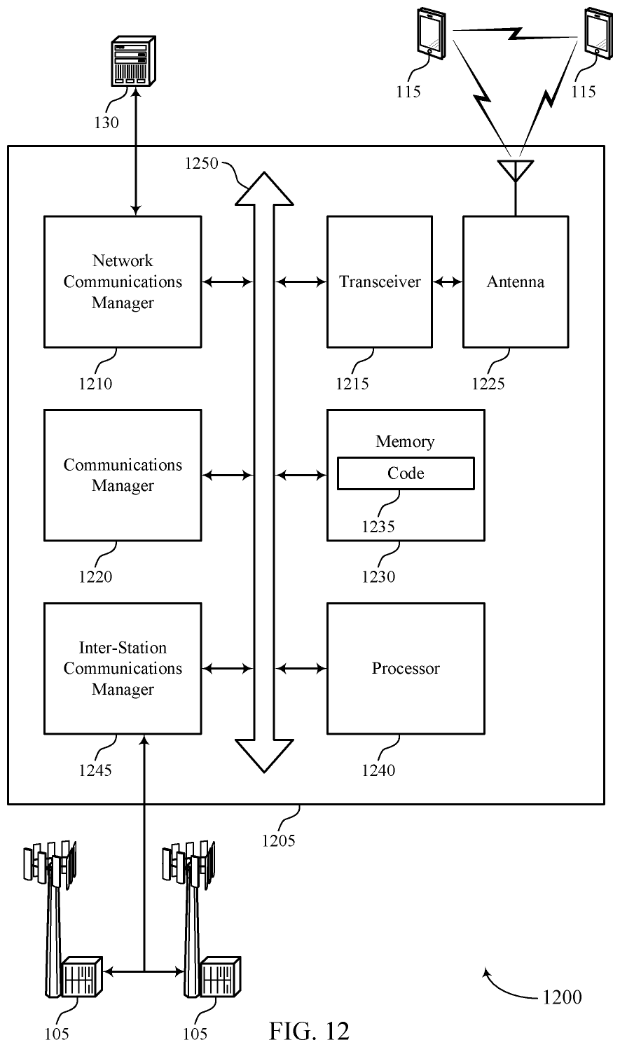

FIG. 12 shows a diagram of a system 1200 including a device 1205 that supports transmit chain switching preparation time for uplink shared channel in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting transmit chain switching preparation time for uplink shared channel). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communication at a base station in accordance with examples as disclosed herein. For example, the communications manager 1220 may be configured as or otherwise support a means for receiving, from a UE, a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE. The communications manager 1220 may be configured as or otherwise support a means for selecting an uplink switching period from among the first uplink switching period and the second uplink switching period. The communications manager 1220 may be configured as or otherwise support a means for receiving, from the UE, an uplink data message after a preparation time that is based on the uplink switching period.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of transmit chain switching preparation time for uplink shared channel as described herein, or the processor 1240 and the memory 1230 may be otherwise configured to perform or support such operations.

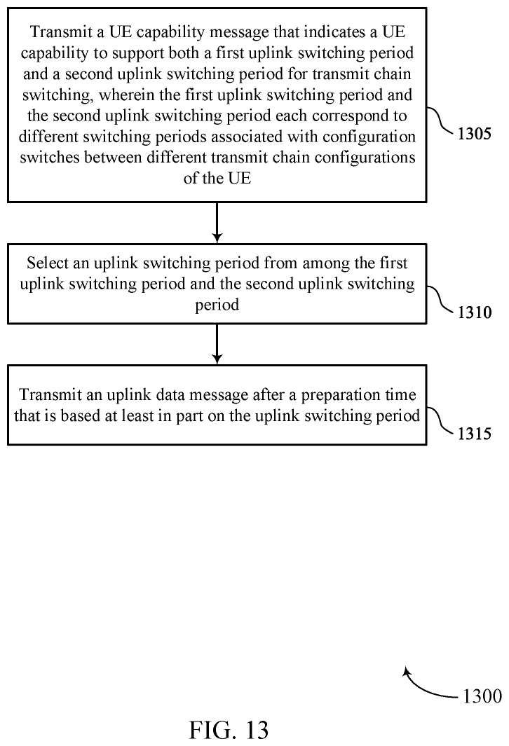

FIG. 13 shows a flowchart illustrating a method 1300 that supports transmit chain switching preparation time for uplink shared channel in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include transmitting a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE. The operations of 1305 may be performed in accordance with examples as disclosed herein. In some examples, aspects of the operations of 1305 may be performed by a UE capability message component 725 as described with reference to FIG. 7.

At 1310, the method may include selecting an uplink switching period from among the first uplink switching period and the second uplink switching period. The operations of 1310 may be performed in accordance with examples as disclosed herein. In some examples, aspects of the operations of 1310 may be performed by an uplink switching period selection component 730 as described with reference to FIG. 7.

At 1315, the method may include transmitting an uplink data message after a preparation time that is based on the uplink switching period. The operations of 1315 may be performed in accordance with examples as disclosed herein. In some examples, aspects of the operations of 1315 may be performed by an uplink data message component 735 as described with reference to FIG. 7.

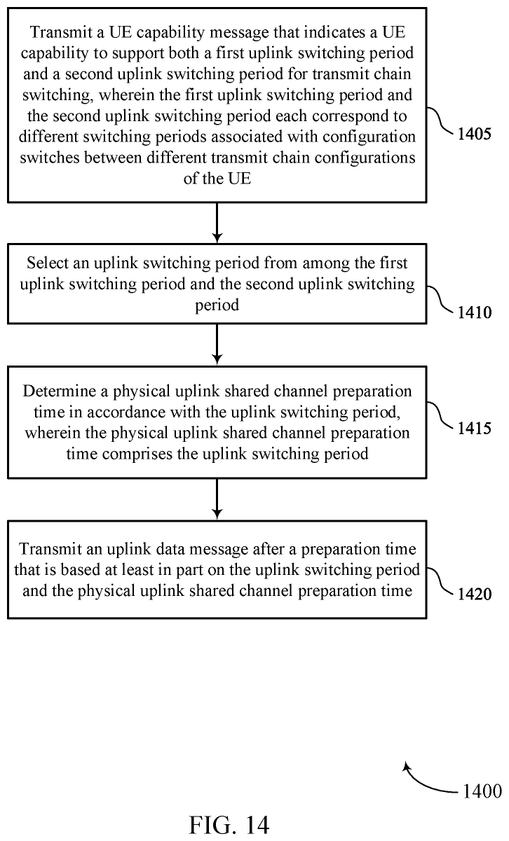

FIG. 14 shows a flowchart illustrating a method 1400 that supports transmit chain switching preparation time for uplink shared channel in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include transmitting a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE. The operations of 1405 may be performed in accordance with examples as disclosed herein. In some examples, aspects of the operations of 1405 may be performed by a UE capability message component 725 as described with reference to FIG. 7.

At 1410, the method may include selecting an uplink switching period from among the first uplink switching period and the second uplink switching period. The operations of 1410 may be performed in accordance with examples as disclosed herein. In some examples, aspects of the operations of 1410 may be performed by an uplink switching period selection component 730 as described with reference to FIG. 7.

At 1415, the method may include determining a PUSCH preparation time in accordance with the uplink switching period, where the PUSCH preparation time includes the uplink switching period. The operations of 1415 may be performed in accordance with examples as disclosed herein. In some examples, aspects of the operations of 1415 may be performed by an PUSCH preparation time component 740 as described with reference to FIG. 7.

At 1420, the method may include transmitting an uplink data message after a preparation time that is based on the uplink switching period and the PUSCH preparation time. The operations of 1420 may be performed in accordance with examples as disclosed herein. In some examples, aspects of the operations of 1420 may be performed by an uplink data message component 735 as described with reference to FIG. 7.

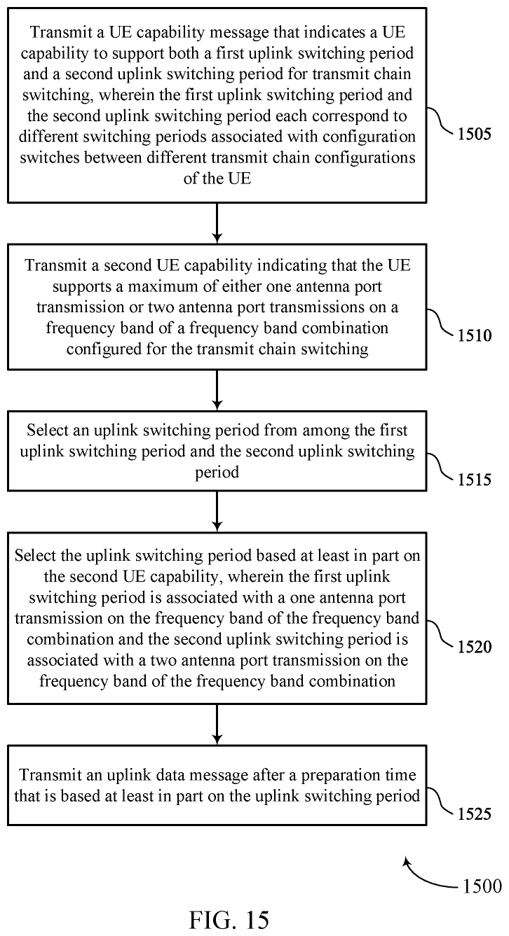

FIG. 15 shows a flowchart illustrating a method 1500 that supports transmit chain switching preparation time for uplink shared channel in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1505, the method may include transmitting a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE. The operations of 1505 may be performed in accordance with examples as disclosed herein. In some examples, aspects of the operations of 1505 may be performed by a UE capability message component 725 as described with reference to FIG. 7.

At 1510, the method may include transmitting a second UE capability indicating that the UE supports a maximum of either one antenna port transmission or two antenna port transmissions on a frequency band of a frequency band combination configured for the transmit chain switching. The operations of 1510 may be performed in accordance with examples as disclosed herein. In some examples, aspects of the operations of 1510 may be performed by an antenna port capability component 745 as described with reference to FIG. 7.

At 1515, the method may include selecting an uplink switching period from among the first uplink switching period and the second uplink switching period. The operations of 1515 may be performed in accordance with examples as disclosed herein. In some examples, aspects of the operations of 1515 may be performed by an uplink switching period selection component 730 as described with reference to FIG. 7.

At 1520, the method may include selecting the uplink switching period based on the second UE capability, where the first uplink switching period is associated with a one antenna port transmission on the frequency band of the frequency band combination and the second uplink switching period is associated with a two antenna port transmission on the frequency band of the frequency band combination. The operations of 1520 may be performed in accordance with examples as disclosed herein. In some examples, aspects of the operations of 1520 may be performed by an uplink switching period selection component 730 as described with reference to FIG. 7.

At 1525, the method may include transmitting an uplink data message after a preparation time that is based on the uplink switching period. The operations of 1525 may be performed in accordance with examples as disclosed herein. In some examples, aspects of the operations of 1525 may be performed by an uplink data message component 735 as described with reference to FIG. 7.

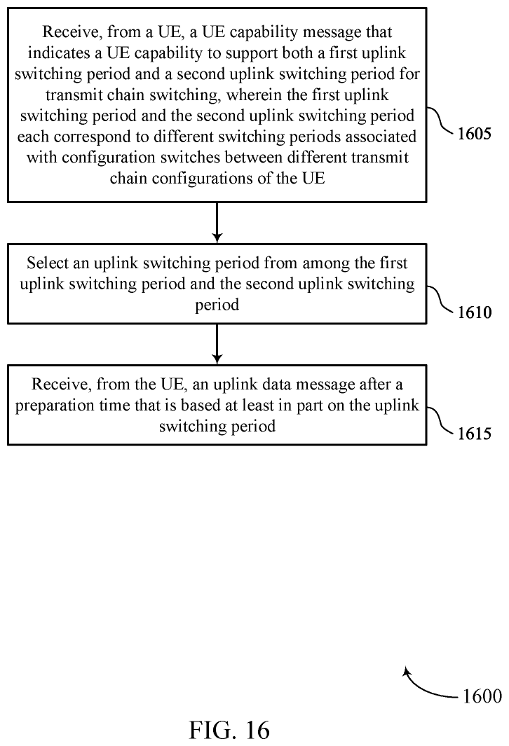

FIG. 16 shows a flowchart illustrating a method 1600 that supports transmit chain switching preparation time for uplink shared channel in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1605, the method may include receiving, from a UE, a UE capability message that indicates a UE capability to support both a first uplink switching period and a second uplink switching period for transmit chain switching, where the first uplink switching period and the second uplink switching period each correspond to different switching periods associated with configuration switches between different transmit chain configurations of the UE. The operations of 1605 may be performed in accordance with examples as disclosed herein. In some examples, aspects of the operations of 1605 may be performed by a UE capability message component 1125 as described with reference to FIG. 11.

At 1610, the method may include selecting an uplink switching period from among the first uplink switching period and the second uplink switching period. The operations of 1610 may be performed in accordance with examples as disclosed herein. In some examples, aspects of the operations of 1610 may be performed by an uplink switching period component 1130 as described with reference to FIG. 11.

At 1615, the method may include receiving, from the UE, an uplink data message after a preparation time that is based on the uplink switching period. The operations of 1615 may be performed in accordance with examples as disclosed herein. In some examples, aspects of the operations of 1615 may be performed by an uplink data message reception component 1135 as described with reference to FIG. 11.

The following provides an overview of aspects of the present disclosure:
Aspect 1: A method for wireless communication at a UE, comprising: transmitting a UE capability message that indicates a UE capability to support both a first uplink switching period and a second uplink switching period for transmit chain switching, wherein the first uplink switching period and the second uplink switching period each correspond to different switching periods associated with configuration switches between different transmit chain configurations of the UE; selecting an uplink switching period from among the first uplink switching period and the second uplink switching period; and transmitting an uplink data message after a preparation time that is based at least in part on the uplink switching period.
Aspect 2: The method of aspect 1, wherein transmitting the UE capability message further comprises: transmitting the UE capability message comprising a first uplink switching period parameter configured to indicate the UE capability to support the first uplink switching period and a second uplink switching period parameter configured to indicate the UE capability to support the second uplink switching period.
Aspect 3: The method of aspect 2, further comprising: selecting the first uplink switching period supported by the UE from a first set of configured uplink switching periods corresponding to the first uplink switching period parameter; and selecting the second uplink switching period supported by the UE from a second set of configured uplink switching periods corresponding to the second uplink switching period parameter.
Aspect 4: The method of any of aspects 1 through 3, further comprising: determining a physical uplink shared channel preparation time in accordance with the uplink switching period, wherein the physical uplink shared channel preparation time comprises the uplink switching period, and wherein the preparation time is based at least in part on the physical uplink shared channel preparation time.
Aspect 5: The method of any of aspects 1 through 4, wherein selecting the uplink switching period further comprises: selecting a maximum duration from among a first duration corresponding to the first uplink switching period and a second duration corresponding to the second uplink switching period, wherein the uplink switching period comprises the maximum duration.
Aspect 6: The method of any of aspects 1 through 4, further comprising: transmitting a second UE capability indicating that the UE supports a maximum of either one antenna port transmission or two antenna port transmissions on a frequency band of a frequency band combination configured for the transmit chain switching.
Aspect 7: The method of aspect 6, wherein selecting the uplink switching period further comprises: selecting the uplink switching period based at least in part on the second UE capability, wherein the first uplink switching period is associated with a one antenna port transmission on the frequency band of the frequency band combination and the second uplink switching period is associated with a two antenna port transmission on the frequency band of the frequency band combination.
Aspect 8: The method of aspect 6, further comprising: receiving a control signal indicating the first uplink switching period or the second uplink switching period, wherein selecting the uplink switching period is based at least in part on the control signal.
Aspect 9: The method of any of aspects 1 through 4, further comprising: receiving a control signal that schedules transmission of the uplink data message according to a first transmit chain configuration, wherein the uplink switching period corresponds to a switching period associated with a configuration switch between the first transmit chain configuration and a second transmit chain configuration of the UE.
Aspect 10: The method of any of aspects 1 through 9, further comprising: determining that the UE supports a first transmit chain and a second transmit chain changeably configured for a one-port transmission, a two-port transmission, or no transmission on each of a first carrier and a second carrier, wherein transmitting the UE capability message is based at least in part on the determining
Aspect 11: The method of aspect 10, wherein the first uplink switching period supports a switching period associated with a configuration switch between a first transmit chain configuration that supports the one-port transmission on the first carrier and a second transmit chain configuration that supports the two-port transmission on the second carrier.
Aspect 12: The method of aspect 10, wherein the first uplink switching period supports a switching period associated with a configuration switch between a first transmit chain configuration that supports the two-port transmission on the first carrier and a second transmit chain configuration that supports the one-port transmission on the second carrier.
Aspect 13: The method of any of aspects 10 through 12, wherein the second uplink switching period supports a switching period associated with a configuration switch between a first transmit chain configuration that supports the two-port transmission on the first carrier and a second transmit chain configuration that supports the two-port transmission on the second carrier.
Aspect 14: The method of any of aspects 1 through 13, wherein transmitting the uplink data message further comprises: transmitting a first uplink data message on a first carrier; switching at least one of a first transmit chain or a second transmit chain between the first carrier and a second carrier during the preparation time; and transmitting the uplink data message on the second carrier in accordance with the switching.
Aspect 15: A method for wireless communication at a base station, comprising: receiving, from a UE, a UE capability message that indicates a UE capability to support both a first uplink switching period and a second uplink switching period for transmit chain switching, wherein the first uplink switching period and the second uplink switching period each correspond to different switching periods associated with configuration switches between different transmit chain configurations of the UE; selecting an uplink switching period from among the first uplink switching period and the second uplink switching period; and receiving, from the UE, an uplink data message after a preparation time that is based at least in part on the uplink switching period.
Aspect 16: The method of aspect 15, wherein receiving the UE capability message further comprises: receiving the UE capability message comprising a first uplink switching period parameter configured to indicate the UE capability to support the first uplink switching period and a second uplink switching period parameter configured to indicate the UE capability to support the second uplink switching period.
Aspect 17: The method of aspect 16, wherein the first uplink switching period supported by the UE is selected from a first set of configured uplink switching periods corresponding to the first uplink switching period parameter; and the second uplink switching period supported by the UE is selected from a second set of configured uplink switching periods corresponding to the second uplink switching period parameter.
Aspect 18: The method of any of aspects 15 through 17, further comprising: determining a physical uplink shared channel preparation time in accordance with the uplink switching period, wherein the physical uplink shared channel preparation time comprises the uplink switching period, and wherein the preparation time is based at least in part on the physical uplink shared channel preparation time.
Aspect 19: The method of any of aspects 15 through 18, wherein selecting the uplink switching period further comprises: selecting a maximum duration from among a first duration corresponding to the first uplink switching period and a second duration corresponding to the second uplink switching period, wherein the uplink switching period comprises the maximum duration.
Aspect 20: The method of any of aspects 15 through 18, further comprising: receiving a second UE capability indicating that the UE supports a maximum of either one antenna port transmission or two antenna port transmissions on a frequency band of a frequency band combination configured for the transmit chain switching.
Aspect 21: The method of aspect 20, wherein selecting the uplink switching period further comprises: selecting the uplink switching period based at least in part on the second UE capability, wherein the first uplink switching period is associated with a one antenna port transmission on the frequency band of the frequency band combination and the second uplink switching period is associated with a two antenna port transmission on the frequency band of the frequency band combination.
Aspect 22: The method of aspect 20, further comprising: transmitting a control signal indicating the first uplink switching period or the second uplink switching period, wherein selecting the uplink switching period is based at least in part on the control signal.
Aspect 23: The method of any of aspects 15 through 18, further comprising: transmitting a control signal that schedules transmission of the uplink data message according to a first transmit chain configuration, wherein the uplink switching period corresponds to a switching period associated with a configuration switch between the first transmit chain configuration and a second transmit chain configuration of the UE.
Aspect 24: The method of any of aspects 15 through 23, further comprising: determining that the UE supports a first transmit chain and a second transmit chain changeably configured for a one-port transmission, a two-port transmission, or no transmission on each of a first carrier and a second carrier, wherein receiving the UE capability message is based at least in part on the determining.
Aspect 25: The method of aspect 24, wherein the first uplink switching period supports a switching period associated with a configuration switch between a first transmit chain configuration that supports the one-port transmission on the first carrier and a second transmit chain configuration that supports the two-port transmission on the second carrier.
Aspect 26: The method of aspect 24, wherein the first uplink switching period supports a switching period associated with a configuration switch between a first transmit chain configuration that supports the two-port transmission on the first carrier and a second transmit chain configuration that supports the one-port transmission on the second carrier.
Aspect 27: The method of any of aspects 24 through 26, wherein the second uplink switching period supports a switching period associated with a configuration switch between a first transmit chain configuration that supports the two-port transmission on the first carrier and a second transmit chain configuration that supports the two-port transmission on the second carrier.
Aspect 28: The method of any of aspects 15 through 27, wherein receiving the uplink data message further comprises: receiving a first uplink data message on a first carrier; and receiving the uplink data message on a second carrier after the preparation time.
Aspect 29: An apparatus for wireless communication, comprising a processor; memory coupled with the processor; and instructions stored in the memory and executable by the processor to cause the apparatus to perform a method of any of aspects 1 through 14.
Aspect 30: An apparatus for wireless communication at a UE, comprising at least one means for performing a method of any of aspects 1 through 14.
Aspect 31: A non-transitory computer-readable medium storing code for wireless communication at a UE, the code comprising instructions executable by a processor to perform a method of any of aspects 1 through 14.
Aspect 32: An apparatus for wireless communication, comprising a processor; memory coupled with the processor; and instructions stored in the memory and executable by the processor to cause the apparatus to perform a method of any of aspects 15 through 28.
Aspect 33: An apparatus for wireless communication at a base station, comprising at least one means for performing a method of any of aspects 15 through 28.
Aspect 34: A non-transitory computer-readable medium storing code for wireless communication at a base station, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
transmitting a UE capability message that indicates a UE capability to support both a first uplink switching period and a second uplink switching period for transmit chain switching, wherein the first uplink switching period and the second uplink switching period each correspond to different switching periods associated with configuration switches between different transmit chain configurations of the UE;
selecting an uplink switching period from among the first uplink switching period and the second uplink switching period; and
transmitting an uplink data message after a preparation time that is based at least in part on the uplink switching period.

2. The method of claim 1, wherein transmitting the UE capability message further comprises:
transmitting the UE capability message comprising a first uplink switching period parameter configured to indicate the UE capability to support the first uplink switching period and a second uplink switching period parameter configured to indicate the UE capability to support the second uplink switching period.

3. The method of claim 2, further comprising:
selecting the first uplink switching period supported by the UE from a first set of configured uplink switching periods corresponding to the first uplink switching period parameter; and
selecting the second uplink switching period supported by the UE from a second set of configured uplink switching periods corresponding to the second uplink switching period parameter.

4. The method of claim 1, further comprising:
determining a physical uplink shared channel preparation time in accordance with the uplink switching period, wherein the physical uplink shared channel preparation time comprises the uplink switching period, and wherein the preparation time is based at least in part on the physical uplink shared channel preparation time.

5. The method of claim 1, wherein selecting the uplink switching period further comprises:
selecting a maximum duration from among a first duration corresponding to the first uplink switching period and a second duration corresponding to the second uplink switching period, wherein the uplink switching period comprises the maximum duration.

6. The method of claim 1, further comprising:
transmitting a second UE capability indicating that the UE supports a maximum of either one antenna port transmission or two antenna port transmissions on a frequency band of a frequency band combination configured for the transmit chain switching.

7. The method of claim 6, wherein selecting the uplink switching period further comprises:
selecting the uplink switching period based at least in part on the second UE capability, wherein the first uplink switching period is associated with a one antenna port transmission on the frequency band of the frequency band combination and the second uplink switching period is associated with a two antenna port transmission on the frequency band of the frequency band combination.

8. The method of claim 6, further comprising:
receiving a control signal indicating the first uplink switching period or the second uplink switching period, wherein selecting the uplink switching period is based at least in part on the control signal.

9. The method of claim 1, further comprising:
receiving a control signal that schedules transmission of the uplink data message according to a first transmit chain configuration, wherein the uplink switching period corresponds to a switching period associated with a configuration switch between the first transmit chain configuration and a second transmit chain configuration of the UE.

10. The method of claim 1, further comprising:
determining that the UE supports a first transmit chain and a second transmit chain changeably configured for a one-port transmission, a two-port transmission, or no transmission on each of a first carrier and a second carrier, wherein transmitting the UE capability message is based at least in part on the determining.

11. The method of claim 10, wherein the first uplink switching period supports a switching period associated with a configuration switch between a first transmit chain configuration that supports the one-port transmission on the first carrier and a second transmit chain configuration that supports the two-port transmission on the second carrier.

12. The method of claim 10, wherein the first uplink switching period supports a switching period associated with a configuration switch between a first transmit chain configuration that supports the two-port transmission on the first carrier and a second transmit chain configuration that supports the one-port transmission on the second carrier.

13. The method of claim 10, wherein the second uplink switching period supports a switching period associated with a configuration switch between a first transmit chain configuration that supports the two-port transmission on the first carrier and a second transmit chain configuration that supports the two-port transmission on the second carrier.

14. The method of claim 1, wherein transmitting the uplink data message further comprises:
transmitting a first uplink data message on a first carrier;
switching at least one of a first transmit chain or a second transmit chain between the first carrier and a second carrier during the preparation time; and
transmitting the uplink data message on the second carrier in accordance with the switching.

15. A method for wireless communication at a base station, comprising:
receiving, from a user equipment (UE), a UE capability message that indicates a UE capability to support both a first uplink switching period and a second uplink switching period for transmit chain switching, wherein the first uplink switching period and the second uplink switching period each correspond to different switching periods associated with configuration switches between different transmit chain configurations of the UE;
selecting an uplink switching period from among the first uplink switching period and the second uplink switching period; and
receiving, from the UE, an uplink data message after a preparation time that is based at least in part on the uplink switching period.

16. The method of claim 15, wherein receiving the UE capability message further comprises:
receiving the UE capability message comprising a first uplink switching period parameter configured to indicate the UE capability to support the first uplink switching period and a second uplink switching period parameter configured to indicate the UE capability to support the second uplink switching period.

17. The method of claim 16, wherein:
the first uplink switching period supported by the UE is selected from a first set of configured uplink switching periods corresponding to the first uplink switching period parameter; and
the second uplink switching period supported by the UE is selected from a second set of configured uplink switching periods corresponding to the second uplink switching period parameter.

18. The method of claim 15, further comprising:
determining a physical uplink shared channel preparation time in accordance with the uplink switching period, wherein the physical uplink shared channel preparation time comprises the uplink switching period, and wherein the preparation time is based at least in part on the physical uplink shared channel preparation time.

19. The method of claim 15, wherein selecting the uplink switching period further comprises:
selecting a maximum duration from among a first duration corresponding to the first uplink switching period and a second duration corresponding to the second uplink switching period, wherein the uplink switching period comprises the maximum duration.

20. The method of claim 15, further comprising:
receiving a second UE capability indicating that the UE supports a maximum of either one antenna port transmission or two antenna port transmissions on a frequency band of a frequency band combination configured for the transmit chain switching.

21. The method of claim 20, wherein selecting the uplink switching period further comprises:
selecting the uplink switching period based at least in part on the second UE capability, wherein the first uplink switching period is associated with a one antenna port transmission on the frequency band of the frequency band combination and the second uplink switching period is associated with a two antenna port transmission on the frequency band of the frequency band combination.

22. The method of claim 20, further comprising:
transmitting a control signal indicating the first uplink switching period or the second uplink switching period, wherein selecting the uplink switching period is based at least in part on the control signal.

23. The method of claim 15, further comprising:
transmitting a control signal that schedules transmission of the uplink data message according to a first transmit chain configuration, wherein the uplink switching period corresponds to a switching period associated with a configuration switch between the first transmit chain configuration and a second transmit chain configuration of the UE.

24. The method of claim 15, further comprising:
determining that the UE supports a first transmit chain and a second transmit chain changeably configured for a one-port transmission, a two-port transmission, or no transmission on each of a first carrier and a second carrier, wherein receiving the UE capability message is based at least in part on the determining.

25. The method of claim 24, wherein the first uplink switching period supports a switching period associated with a configuration switch between a first transmit chain configuration that supports the one-port transmission on the first carrier and a second transmit chain configuration that supports the two-port transmission on the second carrier.

26. The method of claim 24, wherein the first uplink switching period supports a switching period associated with a configuration switch between a first transmit chain configuration that supports the two-port transmission on the first carrier and a second transmit chain configuration that supports the one-port transmission on the second carrier.

27. The method of claim 24, wherein the second uplink switching period supports a switching period associated with a configuration switch between a first transmit chain configuration that supports the two-port transmission on the first carrier and a second transmit chain configuration that supports the two-port transmission on the second carrier.

28. The method of claim 15, wherein receiving the uplink data message further comprises:
receiving a first uplink data message on a first carrier; and
receiving the uplink data message on a second carrier after the preparation time.

29. An apparatus for wireless communication, comprising:
a processor;
memory coupled with the processor; and
instructions stored in the memory and executable by the processor to cause the apparatus to:
transmit a UE capability message that indicates a UE capability to support both a first uplink switching period and a second uplink switching period for transmit chain switching, wherein the first uplink switching period and the second uplink switching period each correspond to different switching periods associated with configuration switches between different transmit chain configurations of the UE;
select an uplink switching period from among the first uplink switching period and the second uplink switching period; and
transmit an uplink data message after a preparation time that is based at least in part on the uplink switching period.

30. An apparatus for wireless communication, comprising:
a processor;
memory coupled with the processor; and
instructions stored in the memory and executable by the processor to cause the apparatus to:
receive, from a user equipment (UE), a UE capability message that indicates a UE capability to support both a first uplink switching period and a second uplink switching period for transmit chain switching, wherein the first uplink switching period and the second uplink switching period each correspond to different switching periods associated with configuration switches between different transmit chain configurations of the UE;
select an uplink switching period from among the first uplink switching period and the second uplink switching period; and
receive, from the UE, an uplink data message after a preparation time that is based at least in part on the uplink switching period.
